(19) United States
(12) Patent Application Publication
(10) Pub. No.: US 2013/0170221 A1
(43) Pub. Date: Jul. 4, 2013

(54) LAMP

(71) Applicants: Toshiaki Isogai, Osaka (JP); Yasuhisa Ueda, Osaka (JP); Kazushige Sugita, Hyogo (JP); Hideo Nagai, Osaka (JP); Takaari Uemoto, Osaka (JP); Masahiro Miki, Osaka (JP); Akira Takahashi, Osaka (JP)

(72) Inventors: Toshiaki Isogai, Osaka (JP); Yasuhisa Ueda, Osaka (JP); Kazushige Sugita, Hyogo (JP); Hideo Nagai, Osaka (JP); Takaari Uemoto, Osaka (JP); Masahiro Miki, Osaka (JP); Akira Takahashi, Osaka (JP)

(73) Assignee: PANASONIC CORPORATION, Osaka (JP)

(21) Appl. No.: 13/823,993

(22) PCT Filed: Oct. 11, 2011
(86) PCT No.: PCT/JP2011/005692

§ 371 Date: Mar. 15, 2013

(30) Foreign Application Priority Data
Oct. 12, 2010 (JP) 2010-229858
Oct. 12, 2010 (JP) 2010-229862

(51) Int. Cl. F21V 7/00

(52) U.S. Cl. CPC F21V 7/0033
USPC 362/300; 362/298

(57) ABSTRACT

A lamp comprises: a primary reflective mirror being funnel-shaped and having an opening at one end; LEDs disposed within the primary reflective mirror; a base attached to another end of the primary reflective mirror; and a circuit configured to receive power via the base and cause the LEDs to emit light. The circuit unit is housed in a circuit case and disposed within the primary reflective mirror close to the opening in a direction in which the LEDs emit light. The circuit case has a secondary reflective surface configured to reflect light emitted from the LEDs to a reflective surface of the primary reflective mirror.

### TECHNICAL FIELD

The present invention relates to a lamp, and in particular to a lamp including a reflective mirror and a circuit unit.

### BACKGROUND ART

In recent years, implementation of high luminance LEDs has triggered an attempt of utilizing a lamp with LEDs as a light source, as a substitute of a halogen light bulb (Patent Literature 1).

Such a lamp using LEDs (hereinafter, simply “LED lamp”) as a substitute of a halogen light bulb has a similar structure to a halogen light bulb, in that the lamp includes a reflective mirror, a plurality of LEDs, a base member, and a circuit unit. The reflective mirror is funnel-shaped and has an opening at one end. The LEDs are provided inside the reflective mirror. The base member is attached to the other end of the reflective mirror, and has a base. The circuit unit receives power via the base, and causes the LEDs to emit light. This circuit unit is stored inside the base member.

The LEDs generate heat when emitting light; however, electronic components that constitute the circuit unit include a component having a low tolerance to heat load. Accordingly, measures are taken to lighten the heat load on the component. For example, a heat dissipation groove is provided in a surface of a housing member (the base member in the present example) for housing the circuit unit (Patent Literature 2). Also, the housing member is made of a metal having high heat conductivity, so that heat generated by the LEDs is conducted to the base, thus preventing accumulation of heat at the housing member (Non-Patent Literature 1, page 12).

### CITATION LIST

### Patent Literature

[Patent Literature 1]
Japanese Patent Application Publication No. 2009-093926
[Patent Literature 2]
Japanese Patent Application Publication No. 2010-003580

### Non-Patent Literature

[Non-Patent Literature 1]
“Lamp Sougou Catalog (Lamp Comprehensive Catalog) 2010” Issued by Panasonic Corporation Lighting Company et al.)

### SUMMARY OF INVENTION

### Technical Problem

There is a demand, for the LED lamp having the structure described above, to have even greater luminance and a smaller size.

However, the above structure has the following problem. That is, when input current to the LEDs is increased in order to improve luminance, the amount of heat generated by the LEDs is increased. This causes a rise in the temperature of the base member, resulting in an increase in the heat load on the circuit unit inside the base member. To efficiently dissipate the aforementioned heat, it is necessary to increase the size of the base member for a larger envelope area or to provide a heat dissipation fin. This makes it difficult to improve luminance without increasing the size of the base member.

Also, suppose that the size of the LED lamp is reduced while maintaining the input current to the LEDs (luminance of the LEDs). For example, if the size of the base member is reduced, heat dissipation characteristics and heat conduction characteristics are lowered, causing a rise in the temperature of the base member and an increase in the heat load on the circuit unit. For this reason, it is difficult to reduce the size of the LED lamp while maintaining the luminance of the LEDs.

The present invention aims to provide a lamp having a new structure that improves luminance without increasing the size of the lamp, and that achieves size reduction while maintaining the luminance of the lamp.

### Solution to Problem

The present invention provides a lamp comprising: a primary reflective mirror being bowl-shaped and having an opening at one end, and having an inner surface serving as a reflective surface; a base provided at another end of the primary reflective mirror; semiconductor light-emitting elements disposed within an envelope composed of at least the primary reflective mirror and the base; a circuit unit configured to receive power via the base and cause the semiconductor light-emitting elements to emit light; and a secondary reflective surface configured to reflect light emitted from the semiconductor light-emitting elements toward the reflective surface of the primary reflective mirror, wherein at least part of the circuit unit is disposed within the primary reflective mirror closer to the opening than to the base in a direction in which the semiconductor light-emitting elements emit light, and the secondary reflective surface is located between the at least part of the circuit unit and the semiconductor light-emitting elements, and reflects light, emitted from the semiconductor light-emitting elements to the at least part of the circuit unit, toward the reflective surface of the primary reflective mirror.

The “envelope” mentioned above is composed of at least the primary reflective mirror and the base. It does not matter whether the envelope has an opening or not (i.e., the envelope may form a closed system or an open system). For example, the envelope may include a front plate for closing the opening of the primary reflective mirror, in addition to the primary reflective mirror and the base. Alternatively, the envelope may include another member, in addition to the primary reflective mirror and the base. In this case, the member is provided between the primary reflective mirror and the base. Yet alternatively, the envelope may include one or more other members, in addition to the primary reflective mirror, the base, and the front plate.

The base may be directly attached to the end of the primary reflective mirror opposite the opening. Alternatively, another member may be provided between the base and the primary reflective mirror.

### Advantageous Effects of Invention

Also, even if a rise in temperature occurs in the base and members surrounding the base due to the heat generated by the semiconductor light-emitting elements during the operation, the circuit unit is less affected by the temperature rise since the circuit unit is disposed at the side of the opening of the primary reflective mirror.

Accordingly, even if the temperature of the base is further raised by another factor such as: an increase in the input current to the semiconductor light-emitting elements; or the size reduction of the members constituting the lamp, the circuit unit is less affected by the heat caused by the temperature rise. This reduces the necessity of new heat dissipation measures. Furthermore, with the secondary reflective surface, the lamp can effectively use the light emitted to the at least part of the circuit unit.

The lamp may further comprise a circuit case, wherein the at least part of the circuit unit may be housed in the circuit case, and the secondary reflective surface may be a surface of the circuit case and face the semiconductor light-emitting elements. This makes it possible to effectively use the surface of the circuit case facing the semiconductor light-emitting elements.

The lamp may further comprise a light focusing member disposed within the primary reflective mirror and configured to focus light emitted from the semiconductor light-emitting elements to the circuit case. Furthermore, the light focusing member may be at least one of a reflector or a lens. This makes it possible to effectively use the light emitted from the semiconductor light-emitting elements.

The semiconductor light-emitting elements and the light focusing member may be mounted on a mounting board. This enables the semiconductor light-emitting elements and the light focusing member to be combined into a unit to simplify the handling thereof.

The lamp may further comprise a front plate, wherein the opening of the primary reflective mirror may be closed by the front plate, and the at least part of the circuit unit may be attached to the front plate. This eliminates the need for a member used for the attachment of the at least part of the circuit unit.

The lamp may further comprise a secondary reflective mirror, wherein the secondary reflective surface may be a reflective surface of the secondary reflective mirror. The reflective surface of the secondary reflective mirror may be either conical or pyramidal, and may face the semiconductor light-emitting elements. This makes it possible to effectively use light directed to the at least part of the circuit unit.

The lamp may further comprise a front plate, wherein the opening of the primary reflective mirror may be closed by the front plate, and the part of the circuit unit may be attached to the front plate. This eliminates the need for a member used for the attachment of the part of the circuit unit.

The part of the circuit unit may be disposed within the primary reflective mirror closer to the opening than to the base in the direction in which the semiconductor light-emitting elements emit light, and a remaining part of the circuit unit may be disposed closer to the base than to the opening and in a direction opposite the direction in which the semiconductor light-emitting elements emit light. This makes it possible to reduce the size of the circuit unit disposed within the main reflective mirror. Furthermore, light emitted from the semiconductor light-emitting elements is less likely to be blocked.

### BRIEF DESCRIPTION OF DRAWINGS

FIG. 1 is a cross-sectional view showing the structure of an LED lamp according to Embodiment 1.

FIG. 2 is a plan view showing the LED lamp according to Embodiment 1 as seen from the side opposite a base.

FIGS. 3A and 3B illustrate an electrical connection. FIG. 3A shows a reflective mirror viewed from the side of the opening. FIG. 3B shows the back surface of a front plate.

FIG. 4 is a cross-sectional view showing the structure of an LED lamp according to Embodiment 2-1.

FIG. 5 is a cross-sectional view showing the structure of an LED lamp according to Embodiment 2-2.

FIG. 6 is a cross-sectional view showing the structure of an LED lamp according to Embodiment 2-3.

FIGS. 7A and 7B are each a plan view showing the LED lamp according to Embodiment 2-3 as seen from the side of an opening of a reflective mirror of the LED lamp, in a state where a front plate of the LED lamp is removed.

FIG. 8 shows the front plate viewed from the side of the reflective mirror.

FIG. 9 is a cross-sectional view showing the structure of an LED lamp according to Embodiment 3-1.

FIG. 10 shows the LED lamp according to Embodiment 3-1 as viewed from the side of an opening of a reflective mirror of the LED lamp.

FIG. 11 is a cross-sectional view showing the structure of an LED lamp according to Embodiment 3-2.

FIG. 12 is a cross-sectional view showing the structure of an LED lamp according to Embodiment 4.

FIG. 13 is a cross-sectional view showing the structure of an LED lamp according to Embodiment 5.

FIGS. 14A and 14B illustrate an electrical connection. FIG. 14A shows a primary reflective mirror viewed from the side of an opening. FIG. 14B shows the back surface of a front translucent plate.

FIG. 15 is a cross-sectional view showing the structure of an LED lamp according to Embodiment 6.

FIGS. 16A and 16B each schematically show the structure of a secondary reflective mirror according to a modification.

### DESCRIPTION OF EMBODIMENTS

In the following embodiments of the present invention, materials, shapes, etc., are described by means of examples, and no limitations are intended thereby. Further, appropriate modifications may be made to the following embodiments provided that these modifications do not deviate from the technical concept of the present invention. Further still, the following embodiments may be combined with each other, provided that no contradictions arise.

Also, the following describes an embodiment in which light emitting diodes (LEDs) are used as semiconductor light-emitting elements. However, laser diodes (LDs) or organic light-emitting elements may be used as semiconductor light-emitting elements.

### Embodiment 1

The following describes in detail Embodiment 1 of the present invention, with reference to the drawings.

### 1. Overall Structure

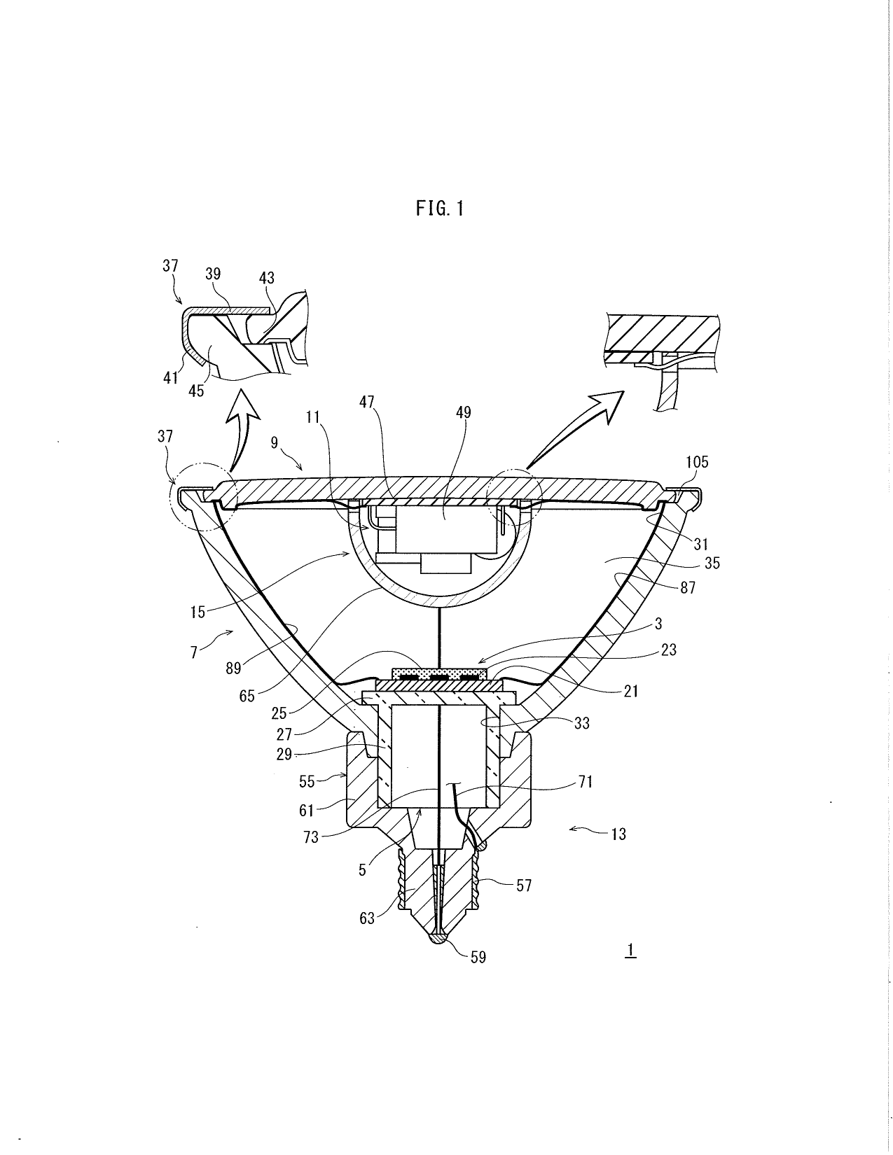

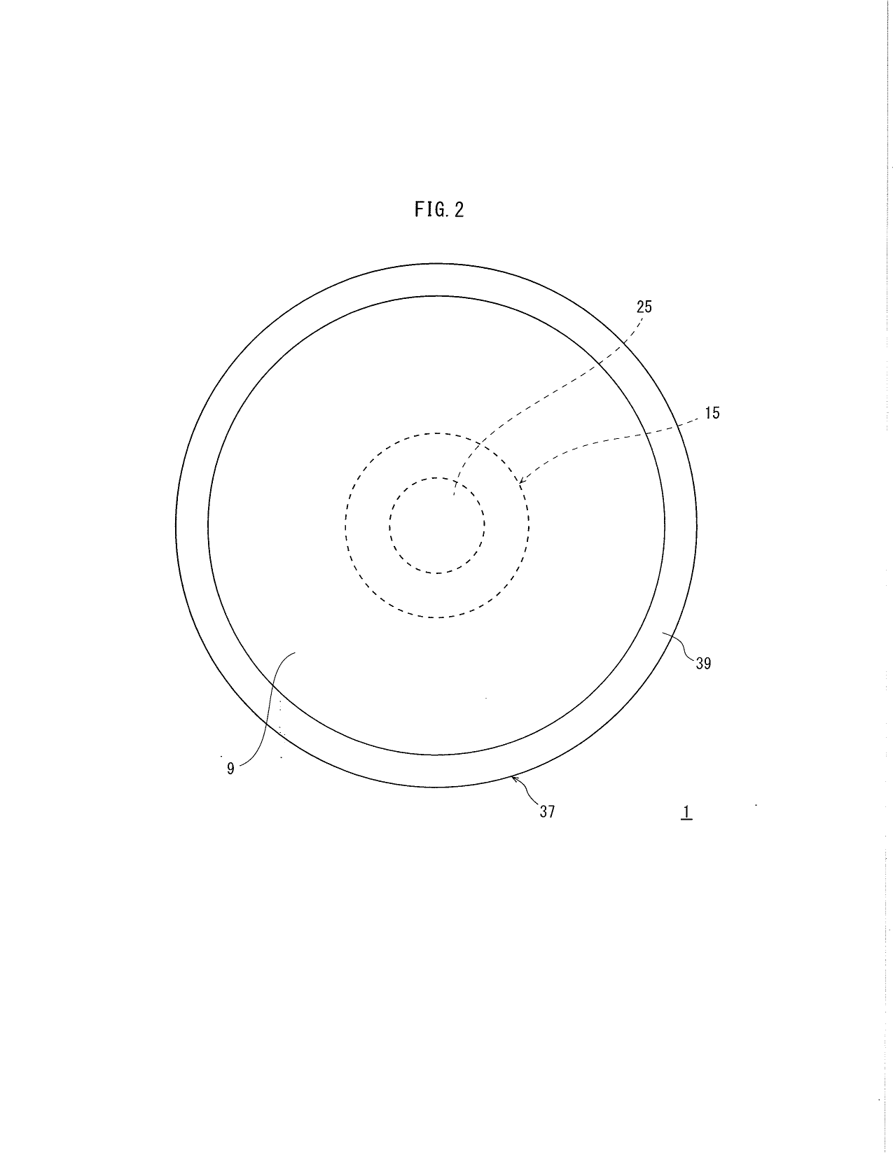

FIG. 1 is a cross-sectional view showing the structure of an LED lamp 1 according to Embodiment 1. FIG. 2 is a plan view showing the LED lamp 1 viewed from the side opposite a base 13.

The LED lamp (corresponding to the “lamp” of the present invention) 1 includes an LED module 3, a mount 5, a primary reflective mirror 7, a front plate 9, a circuit unit 11, a base 13, and a circuit case 15. The LED module 3 includes light emitting diodes (LEDs) 23 as light emitters, and is mounted on the mount 5. The primary reflective mirror 7 houses the LED module 3. The front plate 9 is provided at one end (also referred to as “proximal end”) of the primary reflective mirror 7. The circuit unit 11 causes the LEDs 23 to emit light. The base 13 is electrically connected to the circuit unit 11 which is covered by the circuit case 15.

More specifically, the primary reflective mirror 7 has an opening 31 at one end, and the inner surface of the primary reflective mirror 7 serves as a reflective surface 35. The base 13 is provided at the other end (also referred to as “distal end”) of the primary reflective mirror 7. The primary reflective mirror 7 and the base 13 constitute an envelope, and the LEDs 23, which are semiconductor light-emitting elements, are provided inside the envelope. The circuit unit 11 receives power via the base 13, and causes the LEDs 23 to emit light. The circuit unit 11 is housed in the circuit case 15, and is provided at the side of the opening 31 of the primary reflective mirror 7, in a direction in which the LEDs 23 emit light. The circuit case 15 has a secondary reflective surface 65 which reflects light emitted by the LEDs 23 toward the reflective surface 35 of the primary reflective mirror 7.

For example, the LED lamp 1 is designed to have the same shape and performance as a halogen light bulb having a reflective mirror.

### (1) LED Module

The LED module 3 includes a mounting board 21, the plurality of LEDs 23, and a sealing member 25. The LEDs 23 are mounted on a surface of the mounting board 21. The sealing member 25 covers the LEDs 23 on the mounting board 21.

The mounting board 21 is an insulating plate having a predetermined shape, and has a wiring pattern that connects the LEDs 23 to each other. In the present embodiment, the mounting board 21 is circular in a plan view.

The number of LEDs 23 is appropriately determined depending on the optical characteristics required for the LED lamp 1 (e.g., the amount of light). The LEDs 23 are mounted in a predetermined array.

The sealing member 25 is mainly composed of a translucent material. If the wavelength of light emitted from the LEDs 23 needs to be converted into a predetermined wavelength, the translucent material is mixed with a wavelength conversion material for converting the wavelength of light.

For example, the translucent material may be a silicone resin, and the wavelength conversion material may be phosphor particles.

In the present embodiment, the LEDs 23 emit blue light and, accordingly, phosphor particles for converting blue light into yellow light are used as the wavelength conversion material. In this way, blue light emitted from the LEDs 23 is combined with yellow light resulting from the wavelength conversion by the phosphor particles to produce white light, and the white light is emitted from the LED module 3 (LED lamp 1). Note that the center of a light emitting portion composed of the LEDs 23 is positioned on the optical axis of the primary reflective mirror 7.

### (2) Mount

The mount 5 is composed of a disc 27 and a cylindrical portion 29. The outer diameter of the disc 27 is larger than the outer diameter of the cylindrical portion 29. In the present embodiment, the center of the disc 27 is positioned on the central axis of the cylindrical portion 29. The LED module 3 is mounted at one end of the mount 5, i.e., on one end surface of the disc 27.

The LED module 3 is secured to the mount 5 with use of screws, adhesive, an engaging structure, etc., for example. The LED module 3 is mounted on the mount 5, such that the center of the LED module 3 coincides with the center of the disc 27 in design.

### (3) Primary Reflective Mirror

Although not particularly limited, the primary reflective mirror 7 has the following structure in the present embodiment. That is, the primary reflective mirror 7 has a first opening at one end and a second opening at the other end. The second opening is smaller than the first opening. Also, the reflective mirror is funnel-shaped (bowl-shaped), and the inner surface of the reflective mirror serves as a reflective surface. In other words, the primary reflective mirror 7 has the opening 31 at one end, and a through-hole 33 at the other end which corresponds to the bottom of the primary reflective mirror 7 that is funnel-shaped. The cylindrical portion 29 of the mount 5 is inserted in the through-hole 33. As described below, the cylindrical portion 29 of the mount 5 extends from the through-hole 33 of the primary reflective mirror 7, and the base 13 is attached to the extending part of the cylindrical portion 29.

The recessed surface (i.e., the inner surface) of the funnel-shaped primary reflective mirror 7 is reflective. In other words, the recessed surface of the primary reflective mirror 7 serves as the reflective surface 35. On the reflective surface 35, wiring lines 71, 73, 87, and 89 are provided so as to electrically connect the base 13 to the circuit unit 11, and the circuit unit 11 to the LED module 3.

For example, the primary reflective mirror 7 is made of glass, ceramic, or metal, and the reflective surface 35 is made of a metal film or a white resin.

### (4) Front Plate

The front plate 9 is made of a translucent material, and closes the opening 31 of the primary reflective mirror 7. Accordingly, the front plate 9 is also referred to as a closure. The front plate 9 has the shape of a disc corresponding to the opening 31 of the primary reflective mirror 7. The circuit unit 11 is attached to the back surface of the front plate 9, substantially at the center thereof. Also, the circuit unit 11 is covered by the circuit case 15.

On the back surface of the front plate 9, wiring lines 75, 77, 91, and 93 are provided so as to electrically connect the base 13 to the circuit unit 11, and the circuit unit 11 to the LED module 3. Although not particularly limited, the attachment of the front plate 9 to the primary reflective mirror 7 may be realized by an attachment member 37, for example.

The attachment member 37 utilizes an engaging structure, for example. Specifically, the attachment member 37 has an annular portion 39, and engagement portions 41 provided at different positions of the annular portion 39. The engagement portions 41 engage with a flange 45 at the opening 31 of the primary reflective mirror 7, in a state where the annular portion 39 makes contact with a periphery 43 of the front plate 9.

### (5) Circuit Unit

The circuit unit 11 is composed of a circuit board 47, and various electronic components mounted on the circuit board 47, such as electronic components 49 and 51. The circuit unit 11 is completely housed inside the circuit case 15. The circuit board 47 is attached to the back surface of the front plate 9. The circuit board 47 may be attached to the front plate 9 with use of adhesive, screws, an engaging structure, etc., for example. In the present embodiment, the attachment is realized by adhesive. For simplification, only two electronic components bear reference signs “49” and “51”. However, there are other electronic components than the components 49 and 51. The circuit unit 11 is composed of all of these electronic components including the electronic components 49 and 51.

As described below, the circuit unit 11 is electrically connected to the LED module 3 by the wiring lines 87, 89, 91, and 93, and to the base 13 by the wiring lines 71, 73, 75, and 77.

### (6) Base

There are various types of bases, and the base 13 may be of any type. In the present embodiment, for example, the base 13 is of an Edison type, such as E11 base.

The base 13 is composed of a main body 55, a shell 57, and an eyelet 59. One end of the main body 55 is attached to the primary reflective mirror 7 and the mount 5. The shell 57 is attached to the main body 55. The eyelet 59 is provided at the other end of the main body 55. Note that the shell 57 is connected to the wiring line 71, and the eyelet 59 is connected to the wiring line 73.

The main body 55 has an inner space (i.e., a recess which is recessed from one end of the main body 55 to the other end thereof). Also, the main body 55 includes a large-diameter cylindrical portion 61 and a small-diameter cylindrical portion 63 having a smaller outer diameter than the large-diameter cylindrical portion 61. The large-diameter cylindrical portion 61 is in a bottomed cylindrical shape, and has a cylindrical part. The shape and size of the inner surface of the cylindrical part correspond to those of the outer surface of the cylindrical portion 29 of the mount 5. The small-diameter cylindrical portion 63 extends toward the eyelet 59 from the bottomed end of the large-diameter cylindrical portion 61. The cross section of each of the large-diameter cylindrical portion 61 and the small-diameter cylindrical portion 63 is annular. The central axis of the large-diameter cylindrical portion 61 coincides with the central axis of the small-diameter cylindrical portion 63.

The shell 57 has a threaded outer peripheral surface, and covers the small-diameter cylindrical portion 63. The shell 57 is fixed to the small-diameter cylindrical portion 63 by adhesive. The wiring line 73 passes through the inside of the small-diameter cylindrical portion 63 from one end to the other, and is soldered to the eyelet 59 at the other end of the small-diameter cylindrical portion 63.

Note that the base member described above in the “Background Art” corresponds to the main body 55. Also, the base described above in the “Background Art” corresponds to the combination of (i) the shell 57 attached to the small-diameter cylindrical portion 63 and (ii) the eyelet 59 at the other end of the small-diameter cylindrical portion 63.

### (7) Circuit Case

The circuit case 15 is made of a non-translucent material, and is attached to the front plate 9 so as to cover the circuit unit 11. Although not particularly limited, the attachment of the circuit case 15 to the front plate 9 may be realized with use of adhesive, for example.

In the present embodiment, the circuit case 15 has a hollow hemispherical shape. A surface of the circuit case 15 serves as the secondary reflective surface 65. The secondary reflective surface 65 is made of a metal film or white resin. The center of the hemispherical circuit case 15 coincides with the focal position of the primary reflective mirror 7 in design.

In this way, when light emitted from the LED module 3 has reached the secondary reflective surface 65 of the circuit case 15, the light is reflected by the secondary reflective surface 65 and directed toward the reflective surface 35 of the primary reflective mirror 7. The center of the semispherical circuit case 15 is positioned on the central axis of the cylindrical portion 29 of the mount 5 in design, similarly to the center of the LED module 3.

### 2. Electrical Connection

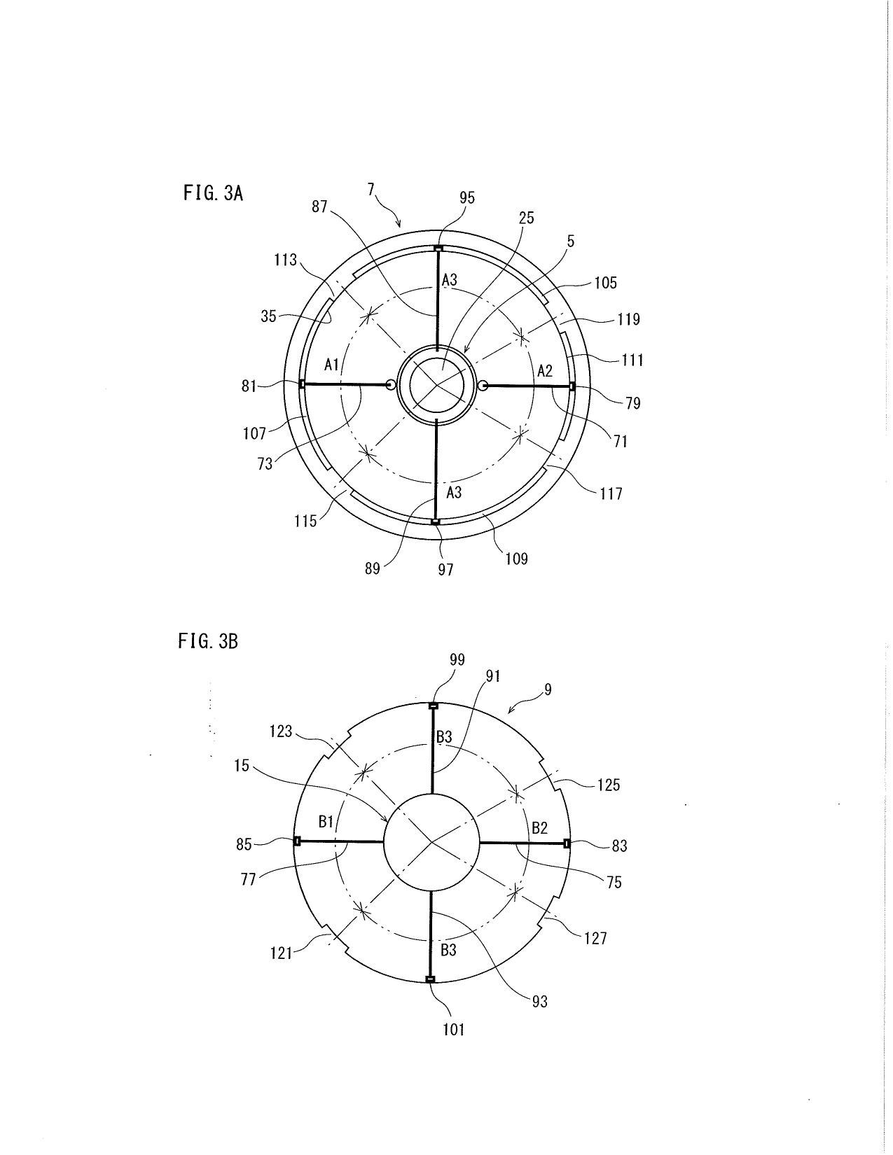

FIGS. 3A and 3B illustrate an electrical connection. FIG. 3A shows the primary reflective mirror 7 viewed from the side of the opening 31. FIG. 3B shows the back surface of the front plate 9.

### (1) Electrical Connection Between Circuit Unit and Base

As described above, the circuit unit 11 and the base 13 are connected to each other via the wiring lines 71, 73, 75, and 77. As shown in FIG. 1 and FIG. 3A, the wiring lines 71 and 73 are provided on the mount 5 and the primary reflective mirror 7. As shown in FIG. 3B, the wiring lines 75 and 77 are provided on the back surface of the front plate 9.

As shown in FIG. 3A, one end of the wiring line 71 is connected to a terminal 79, and one end of the wiring line 73 is connected to a terminal 81, the terminals 79 and 81 being formed on one end surface of the primary reflective mirror 7. The other ends of the wiring lines 71 and 73 are connected to the base 13. As shown in FIG. 3B, one end of the wiring line 75 and one end of the wiring line 77 are respectively connected to a terminal 83 and a terminal 85 which are formed in the vicinity of the periphery of the front plate 9. The other ends of the wiring lines 75 and 77 are connected to the circuit unit 11.

When the front plate 9 is attached to the primary reflective mirror 7, the terminals 83 and 85 on the front plate 9 respectively make contact with the terminals 79 and 81 on the primary reflective mirror 7, whereby the base 13 and the circuit unit 11 are electrically connected to each other.

### (2) Connection Between Circuit Unit and LED Module

As described above, the circuit unit 11 and the LED module 3 are connected to each other via the wiring lines 87, 89, 91, and 93. As shown in FIG. 1 and FIG. 3A, the wiring lines 87 and 89 are provided on the primary reflective mirror 7. As shown in FIG. 3B, the wiring lines 91 and 93 are provided on the back surface of the front plate 9.

As shown in FIG. 3A, one end of the wiring line 87 and one end of the wiring line 89 are respectively connected to a terminal 95 and a terminal 97 which are formed on one end surface of the primary reflective mirror 7. The other ends of the wiring lines 87 and 89 are connected to the LED module 3. As shown in FIG. 3B, one end of the wiring line 91 and one end of the wiring line 93 are respectively connected to a terminal 99 and a terminal 101 which are formed in the vicinity of the periphery of the front plate 9. The other ends of the wiring lines 91 and 93 are connected to the circuit unit 11.

When the front plate 9 is attached to the primary reflective mirror 7, the terminals 99 and 101 on the front plate 9 respectively make contact with the terminals 95 and 97 on the primary reflective mirror 7, whereby the LED module 3 and the circuit unit 11 are electrically connected to each other.

### (3) Prevention of Erroneous Attachment

As shown in FIG. 1 and FIGS. 3A and 3B, a plurality of steps (four steps in the present embodiment) are formed at an opening end of the primary reflective mirror 7. Specifically, steps 105, 107, 109, and 111 are formed along the periphery of the opening of the primary reflective mirror 7.

Along the periphery of the front plate 9, cutouts 121, 123, 125, and 127 are formed. The cutouts 121, 123, 125, and 127 correspond to inter-step gaps 113, 115, 117, and 119 that are each a gap between two adjacent steps from among the steps 105, 107, 109, and 111 of the primary reflective mirror 7.

An angle A1 between the center of the inter-step gap 113 and the center of the inter-step gap 115 is the same as an angle B1 between the center of the cutout 121 and the center of the cutout 123. An angle A2 between the center of the inter-step gap 117 and the center of the inter-step gap 119 is the same as an angle B2 between the center of the cutout 125 and the center of the cutout 127.

An angle A3 between the center of the inter-step gap 113 and the center of the inter-step gap 119 and an angle A3 between the center of the inter-step gap 115 and the center of the inter-step gap 117 are the same as an angle B3 between the center of the cutout 123 and the center of the cutout 125 and an angle B3 between the center of the cutout 121 and the center of the cutout 127.

Here, the angles A1 and B1 are different from the angles A2 and B2. The back surface of the front plate 9 makes contact with the edge of the opening 31 of the primary reflective mirror 7 only when the cutouts 121, 123, 125, and 127 of the front plate 9 are respectively positioned at the inter-step gaps 113, 115, 117, 119 (i.e., no other positional relationships enable the contact between the back surface of the front plate 9 and the edge of the opening 31).

### 3. Heat Dissipation Path

Since the LED lamp 1 according to the present embodiment has the stated structure, heat generated by the LEDs 23 while the LED lamp 1 is lit is conducted from the mount 5 to the base 13, and then dissipated, via a socket of a lighting fixture, to the main body of the lighting fixture, and to the wall and the ceiling to which the lighting fixture is attached.

Accordingly, even if, for example, the input current to the LEDs 23 is increased in order to improve the luminance, and the amount of heat generated by the LEDs 23 during the operation is increased, the generated heat is conducted from the base 13 to the lighting fixture. Since the circuit unit 11 does not need to be disposed between the LED module 3 and the base 13, the distance between the LED module 3 and the base 13 can be shortened. This makes it possible to increase the amount of heat conducted from the LED module 3 to the base 13.

Also, suppose that some heat generated by the LEDs 23 remains within the LED module 3 and the mount 5 without being conducted to the base 13, and that the temperatures of the LED module 3 and the mount 5 rise. Even in such a case, the heat load on the circuit unit 11 does not increase to a significant degree, since the circuit unit 11 is disposed opposite the base 13 with respect to the LED module 3, i.e., at the side of the opening 31 of the primary reflective mirror 7.

As described above, the LED lamp 1 is configured so that the heat load on the circuit unit 11 does not increase even if the temperatures of the LED module 3 and the mount 5 rise. Therefore, it is not necessary to provide heat dissipating means, such as a heat sink, for lowering the temperatures of the LED module 3 and the mount 5, which is advantageous in terms of preventing upsizing of the LED lamp 1.

Also, since the circuit unit 11 is disposed at the side of the opening 31 of the primary reflective mirror 7, there is no need to secure a space between the LED module 3 and the base 13 for disposing the circuit unit 11. This enables downsizing of an end portion of the primary reflective mirror 7 at the distal end thereof; the mount 5; the main body 55 of the base 13; and so on.

Due to the downsizing of the aforementioned components, there is a possibility of temperature rise in the base 13 and the mount 5 on which the LED module 3 is mounted. However, since the circuit unit 11 is not located between the LED module 3 and the base 13, the circuit unit 11 is less affected by the temperature rise.

### 4. Other

In the present embodiment, the circuit unit 11 is provided at the side of the opening 31 of the primary reflective mirror 7. This eliminates the need of securing a space between the mount 5 and the base 13 for housing the circuit unit 11. As a result, the LED module 3 can be disposed close to the base 13, allowing the use of the primary reflective mirror 7 having a shape and size similar to those of a reflective mirror of a halogen light bulb. Consequently, the LED lamp 1 having the stated structure can fit to a conventional lighting fixture for a halogen light bulb at a rate of approximately 100%.

Moreover, disposing the LED module 3 close to the base 13 enables the distance between the LED module 3 and the top of the primary reflective mirror 7 (i.e., the top part shown in FIG. 1) to be increased, thus sufficiently securing a space for disposing the circuit unit 11.

### Embodiment 2

According to Embodiment 1, the LED lamp does not include a light focusing means for focusing light emitted from the LED module 3 to the circuit case 15 disposed in front of the LED module 3 (in the direction in which the LED module 3 emits light). However, an LED lamp according to Embodiment 2 includes a reflector as the light focusing means, so that the light emitted from the LED module 3 can be efficiently reflected on the secondary reflective surface 65 of the circuit case 15 toward the primary reflective mirror 7. Note that the same reference signs are applied to the same elements as in Embodiment 1 described above.

### 1. Embodiment 2-1

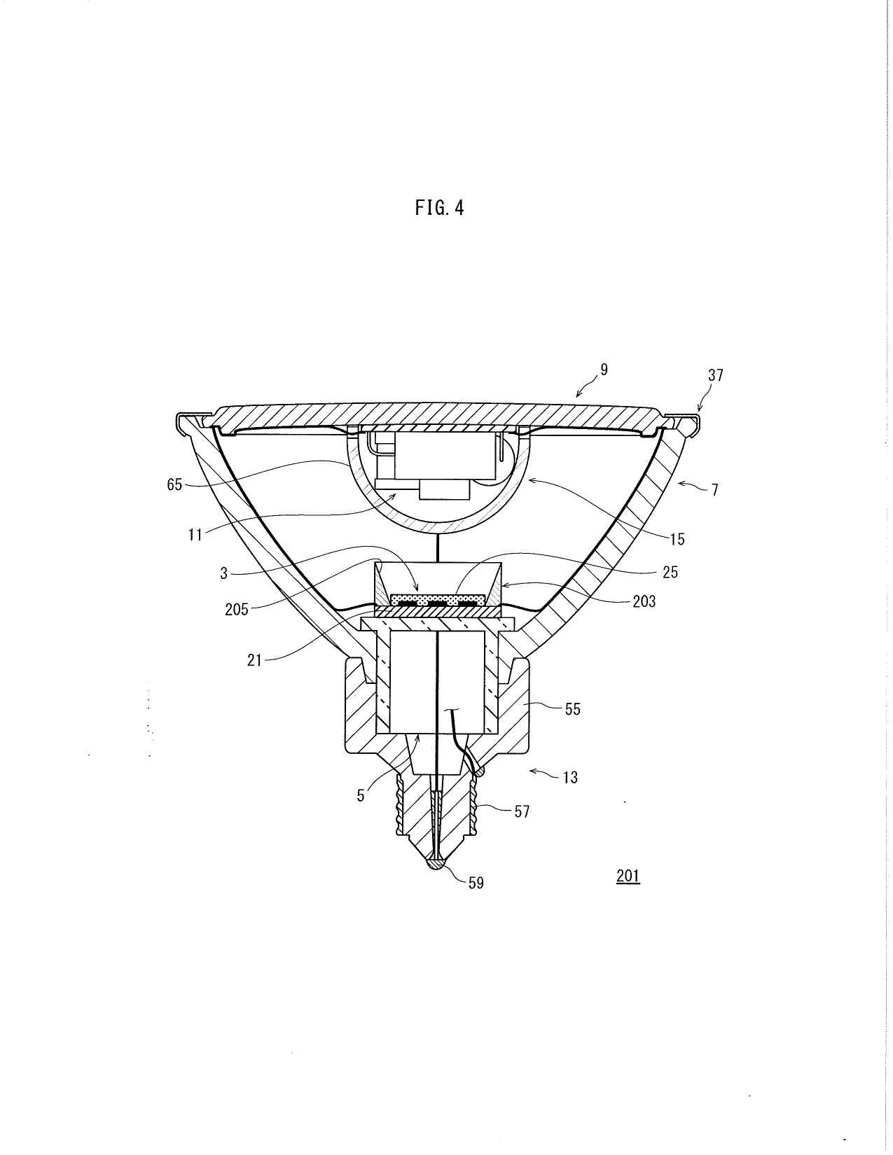

FIG. 4 is a cross-sectional view showing the structure of an LED lamp 201 according to Embodiment 2-1.

The LED lamp 201 includes a reflector 203 for reflecting light emitted from the LED module 3 toward the circuit case 15, in addition to the LED module 3, the mount 5, the primary reflective mirror 7, the front plate 9, the circuit unit 11, the base 13, and the circuit case 15. Note that one of the surfaces of the circuit case 15 that faces the LED module 3 is the secondary reflective surface 65.

In the present embodiment, the reflector 203 has a tubular shape surrounding the sealing member 25 of the LED module 3. The tubular reflector 203 is mounted on the mounting board 21 of the LED module 3, such that the central axis of the reflector 203 coincides with the center of the light emitting portion of the LED module 3.

The inner peripheral surface of the reflector 203 is inclined and flared, so that the inner diameter of the tubular reflector 203 increases with distance from the LED module 3 along the central axis of the reflector 203 (i.e., along the optical axis of the primary reflective mirror 7). In the present embodiment, the inclined surface of the reflector 203 has a linear cross section, and serves as a reflective surface 205.

If the reflector 203 is made of a metal material, the reflective surface 205 may be formed by giving the reflector 203 a mirror finish. If the reflector 203 is made of a resin material, the reflective surface 205 may be formed by plating the reflector 203 or by coating the reflector 203 with a white film.

### 2. Embodiment 2-2

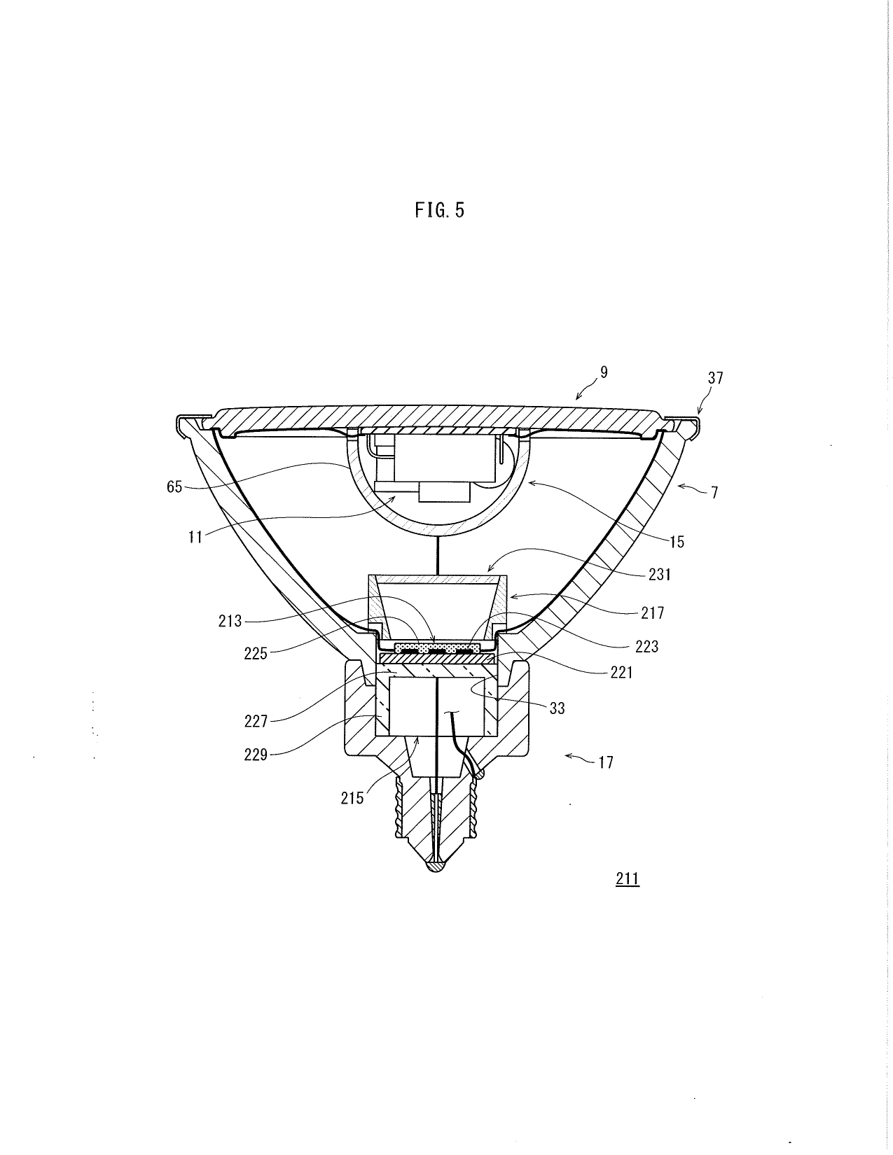

FIG. 5 is a cross-sectional view showing the structure of an LED lamp 211 according to Embodiment 2-2.

The LED lamp 211 includes an LED module 213, a mount 215, the primary reflective mirror 7, the front plate 9, the circuit unit 11, the base 13, the circuit case 15, and a reflector 217. Note that one of the surfaces of the circuit case 15 that faces the LED module 3 is the secondary reflective surface 65.

The LED module 213 includes a mounting board 221, LEDs 223, and a sealing member 225, as in Embodiment 1. In the present embodiment, the LEDs 223 emit blue light, but the sealing member 225 does not contain a wavelength converting material. That is, the LED module 213 emits blue light.

As in Embodiment 1, the mount 215 is composed of a disc 227 and a cylindrical portion 229. The outer diameter of the disc 227 coincides with the outer diameter of the cylindrical portion 229, and also coincides with the diameter of the through-hole 33 at the distal end of the primary reflective mirror 7.

Concerning the mount 215, an end portion of the mount 215 closer to the disc 227, i.e., a portion including the disc 227 and a part of the cylindrical portion 229, is inserted in the through-hole 33 of the primary reflective mirror 7. Also, a portion of the cylindrical portion 229 not inserted in the through-hole 33 fits in the base 13. The LED module 213 is mounted on the disc 227 of the mount 215, and is located within the through-hole 33 of the primary reflective mirror 7.

The reflector 217 is cylindrical as in Embodiment 2-1, and is mounted on the primary reflective mirror 7 in a state where an end of the reflector 217 closer to the base 13 is fit in the through-hole 33 of the primary reflective mirror 7. The reflector 217 may be mounted with use of adhesive, screws, an engaging structure, etc., for example. The inner surface of the reflector 217 serves as a reflective surface.

Attached to the reflector 217 is a wavelength converter 231 that converts light (blue light in the present embodiment) emitted from the LED module 213 into light having a predetermined color (yellow light in the present embodiment). The wavelength converter 231 may have a plate-like shape and be composed of a main material (e.g., translucent resin material, ceramic material, etc.) containing a wavelength conversion material (e.g., phosphor particles, etc.). Alternatively, the wavelength converter 231 may be composed of a translucent plate and at least one wavelength conversion film formed thereon. Specifically, the wavelength conversion film is formed on at least one of the main surfaces of the translucent plate, and contains a wavelength conversion material.

In this way, the LED lamp 211 emits white light which is a combination of the blue light emitted from the LED module 213 and the yellow light resulting from the wavelength conversion by the wavelength converter.

### 3. Embodiment 2-3

### (1) Structure

According to Embodiment 1 and Embodiments 2-1 and 2-2, the plurality of LEDs are mounted on a single mounting board. However, the LEDs may be mounted on a plurality of mounting boards. In other words, the number of LED modules disposed within the primary reflective mirror may be one or more. The following describes an example where five LED modules are disposed within the primary reflective mirror. Note that one of the surfaces of the circuit case 15 that faces the LED module 3 is the secondary reflective surface 65.

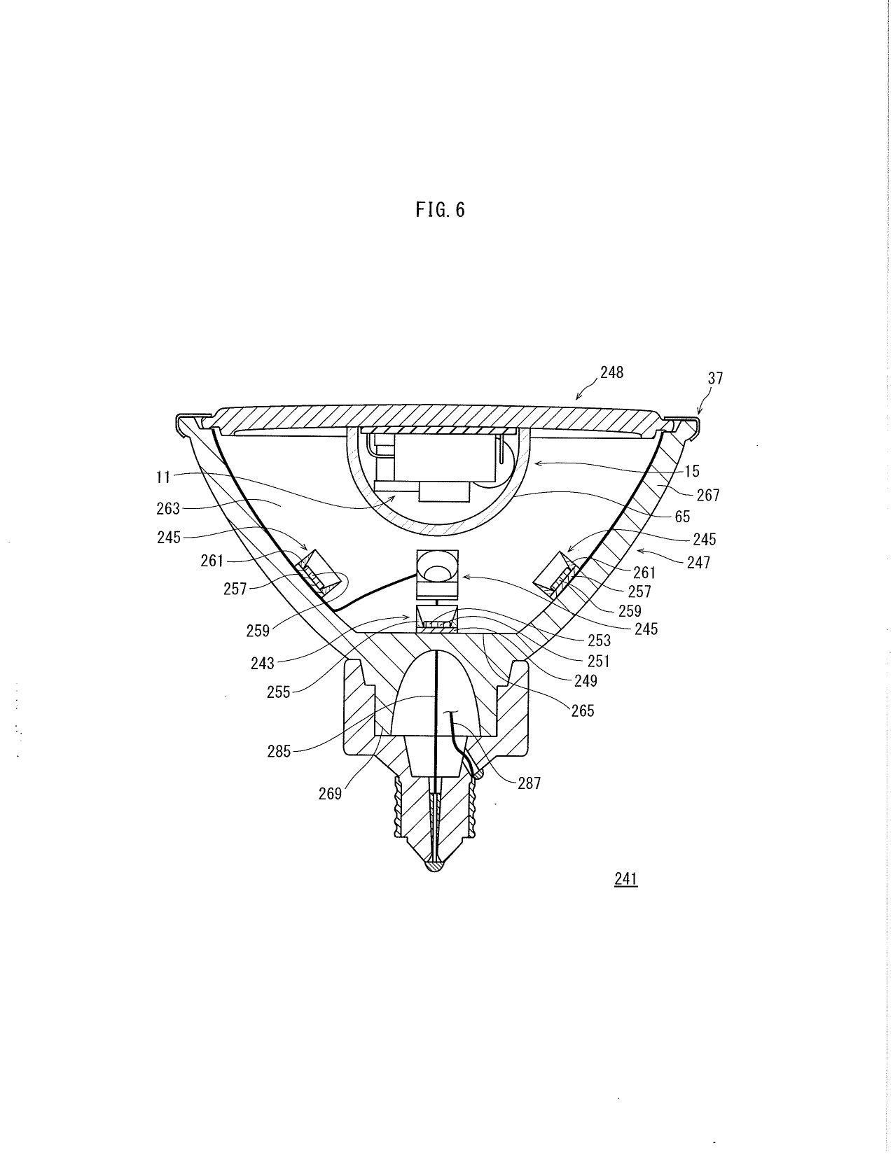

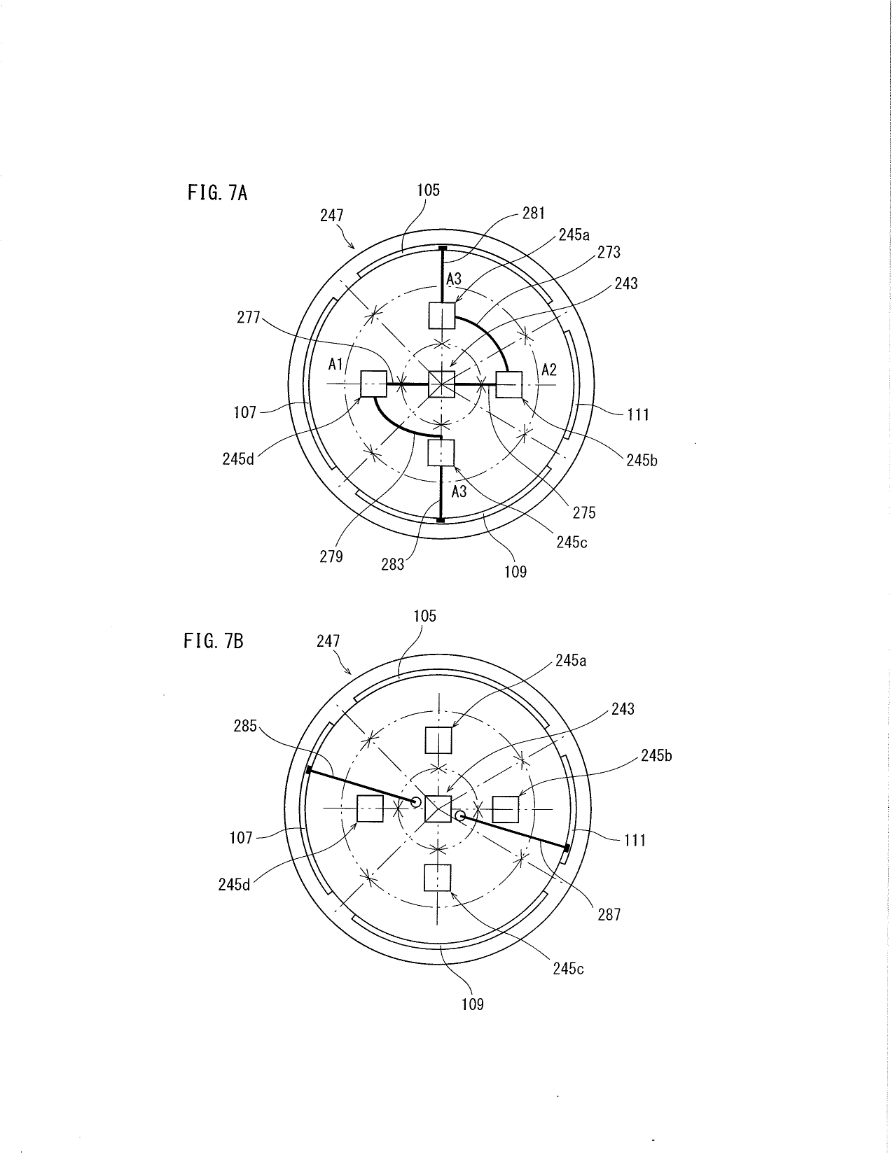

FIG. 6 is a cross-sectional view showing the structure of an LED lamp 241 according to Embodiment 2-3. FIGS. 7A and 7B each show the LED lamp 241 viewed from the side of the opening of a primary reflective mirror 247, in a state where a front plate 248 of the LED lamp 241 has been removed.

The LED lamp 241 includes five LED modules, i.e., LED modules 243, 245, 245, 245, and 245, a primary reflective mirror 247, a front plate 248, the circuit unit 11, the base 13, and the circuit case 15. The LED module 243 is different from the other four LED modules 245, in terms of the number of LEDs mounted thereon.

The LED module 243 includes a mounting board 249, an LED 251, a sealing member 253, and a reflector 255. The reflector 255 focuses (reflects) light emitted from the LED 251 toward the circuit case 15. The reflector 255 is mounted on an area, of a surface of the mounting board 249, in which the sealing member 253 is not formed.

Each of the LED modules 245 includes a mounting board 257, two LEDs, a sealing member 259, and a reflector 261. Similarly to the reflector 255, the reflector 261 focuses (reflects) light emitted from the LEDs toward the circuit case 15. The reflector 261 is mounted on an area, of a surface of the mounting board 257, in which the sealing member 259 is not formed.

As in Embodiments 2-1 and 2-2, each of the reflectors 255 and 261 is tubular and has an inner peripheral surface that is inclined and flared. Materials, etc. for forming the reflectors 255 and 261 and the reflective surfaces thereof are the same as in Embodiments 2-1 and 2-2. However, the reflectors 255 and 261 and the reflective surfaces thereof may have different structures.

The primary reflective mirror 247 has an elliptical surface 263, a bottom surface 265, a main body 267, and a protrusion 269. The elliptical surface 263 is part of a spheroidal surface whose longitudinal axis coincides with the optical axis. The bottom surface 265 is perpendicular to the optical axis. The inner surface of the main body 267 is composed of the elliptical surface 263 and the bottom surface 265. The protrusion 269 protrudes outward from a distal end of the main body 267, which is an end located opposite an open end of the primary reflective mirror 247. The protrusion 269 is covered by the base 13.

As shown in FIG. 6 and FIGS. 7A and 7B, the LED module 243 is mounted on the bottom surface 265 of the primary reflective mirror 247, more specifically at the center of the bottom surface 265 through which the optical axis passes. The four LED modules 245 are mounted on the elliptical surface 263 of the primary reflective mirror 247, close to the bottom surface 265. The four LED modules 245 are arranged at equal intervals in the peripheral direction of the elliptical surface 263.

The LED modules 243, 245, 245, 245, and 245 are disposed on the inner surface of the primary reflective mirror 247 (i.e., mounted directly on the primary reflective mirror 247 without a mount between the LED modules 243, 245, 245, 245, and 245 and the primary reflective mirror 247), with the reflector 255 of the LED module 243 and the reflectors 261 of the LED modules 245 facing the circuit case 15. The circuit case 15 is hemispherical, and the center thereof coincides with the focal point of the primary reflective mirror 247 in design.

In FIGS. 7A and 7B, in order to distinguish the four LED modules 245 having the same structure, the letters “a” through “d” are attached to the respective reference signs “245”.

### (2) Electrical Connection

In Embodiment 2-3, the five LED modules 243, 245, 245, 245, and 245 are connected in series with respect to the circuit unit 11 by wiring lines 273, 275, 277, and 279, as shown in FIG. 7A. In other words, the LED module 245a and the LED module 245b are connected by the wiring line 273. The LED module 245b and the LED module 243 are connected by the wiring line 275. The LED module 243 and the LED module 245d are connected by the wiring line 277. The LED module 245d and the LED module 245c are connected by the wiring line 279.

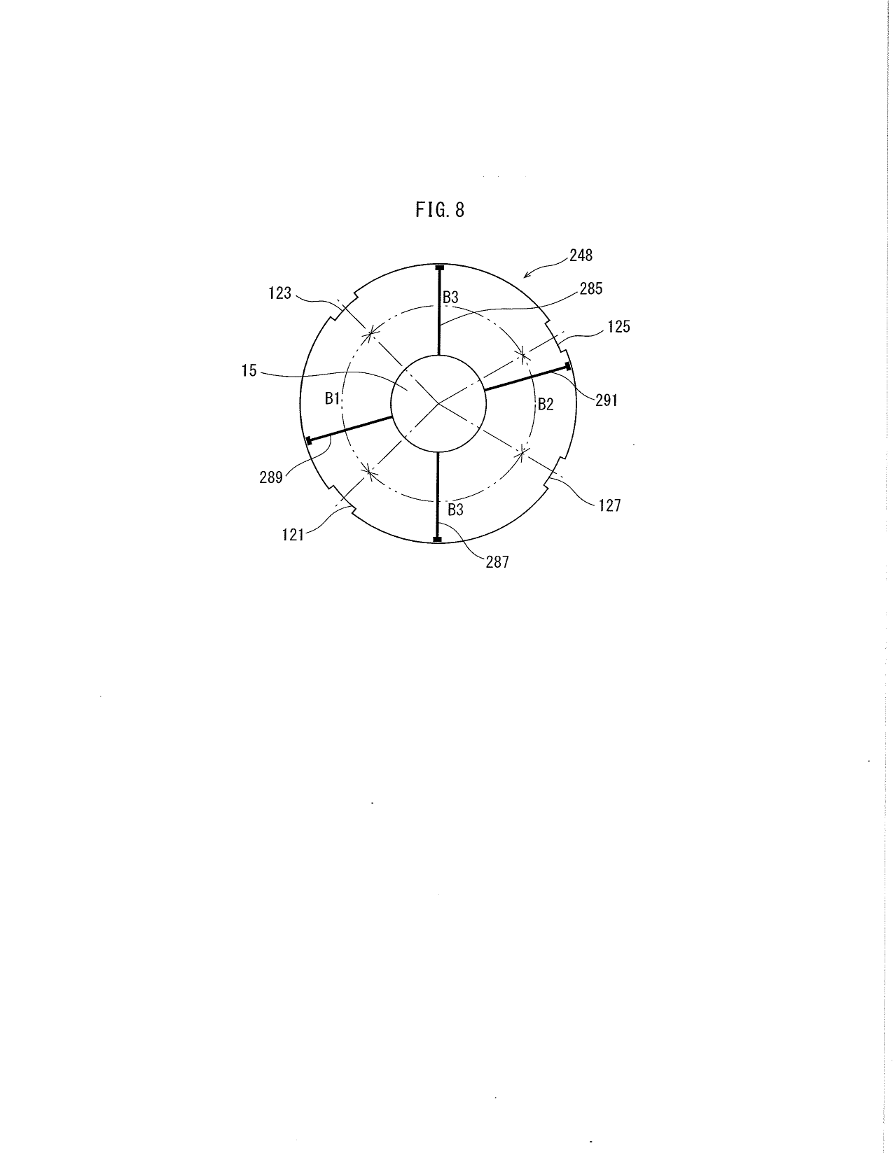

FIG. 8 shows the front plate 248 viewed from the side of the primary reflective mirror 247 (i.e., shows the back surface of the front plate 248).

As shown in FIGS. 7A and 8, the LED module 245a and the circuit unit 11 are connected by a wiring line 281 within the primary reflective mirror 247 and a wiring line 285 on the back surface of the front plate 248; the LED module 245c and the circuit unit 11 are connected by a wiring line 283 within the primary reflective mirror 247 and a wiring line 287 on the back surface of the front plate 248.

As shown in FIGS. 7B and 8, the base 13 and the circuit unit 11 are connected by wiring lines 285 and 287 provided for the base 13 and the primary reflective mirror 247 and wiring lines 289 and 291 on the back surface of the front plate 248.

In order to prevent erroneous attachment of the front plate 248 to the primary reflective mirror 247, the steps 105, 107, 109, and 111, which differ from each other in length and intervals, are formed along the periphery of the opening of the primary reflective mirror 247. Also, the cutouts 121, 123, 125, and 127 are formed along the periphery of the front plate 248.

### Embodiment 3

In Embodiment 2, the LED lamp includes a reflector as a light focusing means, so that the light emitted from the LED module(s) is efficiently focused to the circuit case 15. However, an LED lamp according to Embodiment 3 includes a lens as a light focusing means. Note that the same reference signs are applied to the same elements as in Embodiments 1 and 2 described above.

### 1. Embodiment 3-1

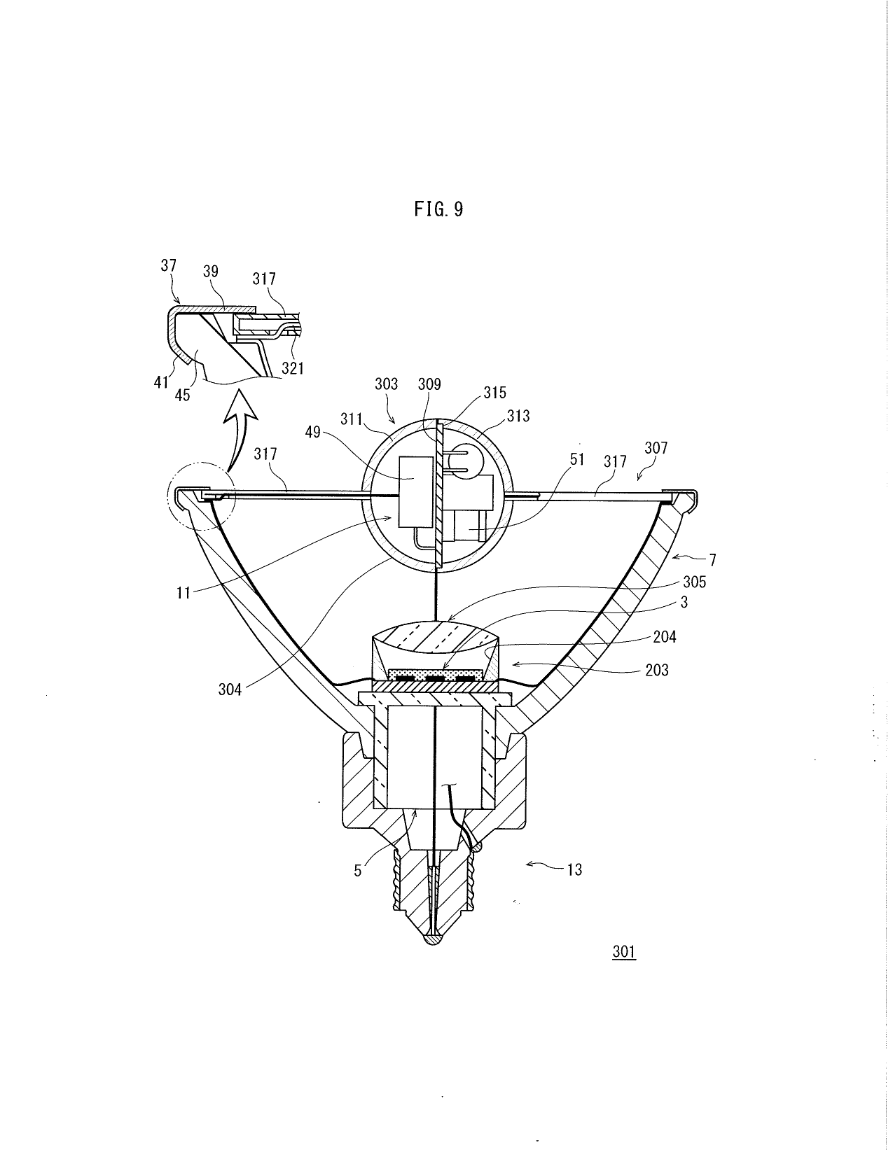

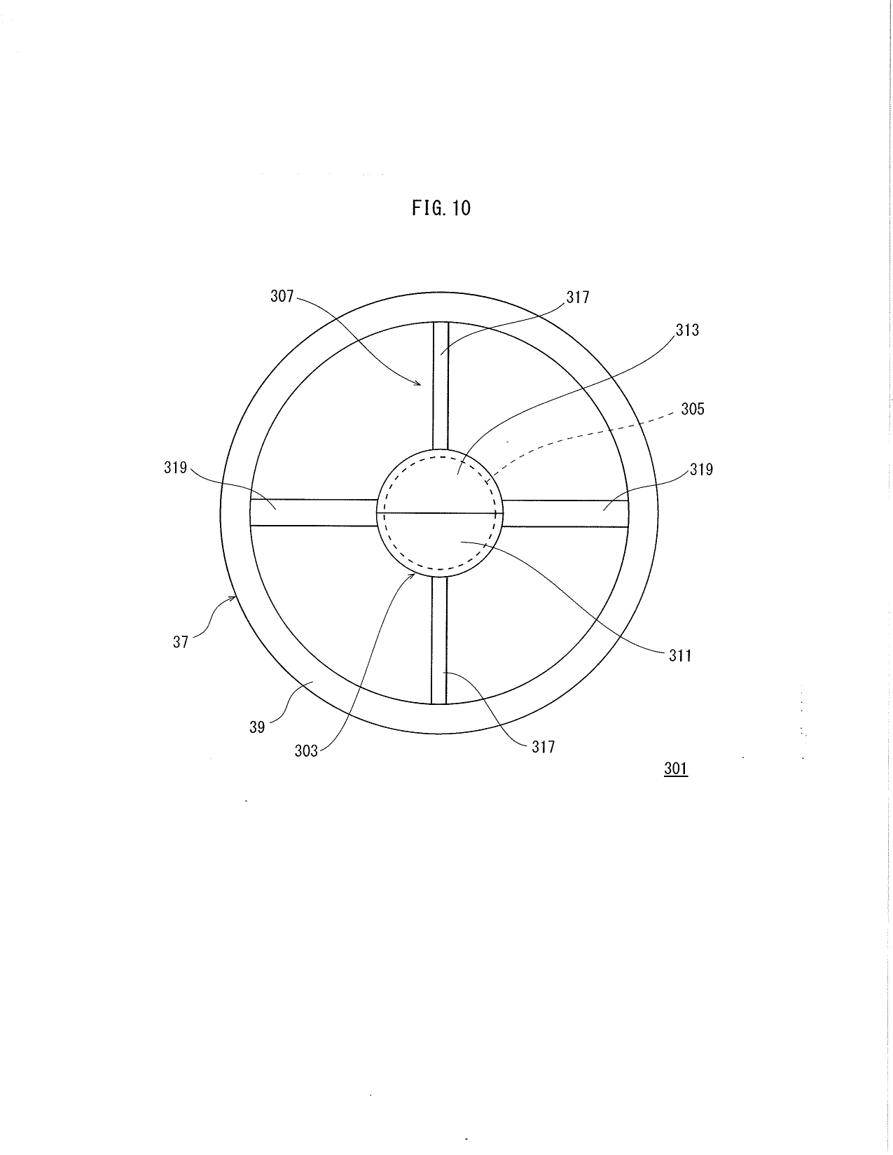

FIG. 9 is a cross-sectional view showing the structure of an LED lamp 301 according to Embodiment 3-1. FIG. 10 shows the LED lamp 301 viewed from the side of the opening of the primary reflective mirror 7.

The LED lamp 301 includes a lens 305, a circuit case 303, and a support 307 for supporting the circuit case 303, in addition to the LED module 3, the mount 5, the primary reflective mirror 7, the circuit unit 11, and the base 13.

The reflector 203 described above in Embodiment 2-1 is mounted on the LED module 3. The lens 305 is mounted so as to close an opening of the reflector 203. The lens 305 is convex, and the LEDs constituting the light emitting portion are positioned at the focal point of the lens 305. For example, if the number of LEDs is two, the center of the distance between the two LEDs is the focal point. In this way, the lens 305 collimates light emitted from the LED module 3 into parallel rays of light that travel along the optical axis.

The circuit unit 11 includes a circuit board 309, a plurality of electronic components, such as the electronic components 49 and 51, mounted on both main surfaces of the circuit board 309.

By appearance, the circuit case 303 has a hollow spherical shape, and houses the circuit unit 11 in a spherical inner space thereof. The circuit case 303 is composed of two hemispherical members, i.e., a first member 311 and a second member 313, which are obtained by dividing the spherical circuit case 303 into two portions along the plane parallel to the optical axis of the primary reflective mirror 7. As in Embodiment 1, part of the outer peripheral surface of the circuit case 303 positioned within the primary reflective mirror 7 serves as a secondary reflective surface 304.

The second member 313 has a recess 315 in which the outer periphery of the circuit board 309 of the circuit unit 11 is fit. With the outer periphery of the circuit board 309 being fit in the recess 315, an open end of the first member 311 is joined with an open end of the second member 313, whereby the circuit case 303 is formed.

The outer periphery of the circuit board 309 is fixed by being fit in the recess 315 of the second member 313 and held between the first member 311 and the second member 313. As such, the circuit unit 11 is fixed to the circuit case 303.

Note that the method for fixing the circuit unit 11 to the circuit case 303 is not limited to the above. Instead, the circuit board 309 may be fixed to the circuit case 303 by screws or adhesive, for example.

The circuit case 303 is disposed at the side of the opening 31 of the primary reflective mirror 7, and is supported by the support 307 mounted on the primary reflective mirror 7. As shown in FIG. 10, the support 307 is composed of four tubular members 317, 317, 319, and 319, each of which is connected and fixed to the edge of the opening 31 of the primary reflective mirror 7 at one end and to the circuit case 303 at the other end.

The tubular members 317 are different from the tubular members 319 in terms of thickness (outer diameter), in order to prevent erroneous attachment to the primary reflective mirror 7 of the circuit case 303.

Wiring lines 321, 321, 321, and 321 are inserted in the tubular members 317, 317, 319, and 319, respectively. The wiring lines 321, 321, 321, and 321 connect the terminals 79, 81, 95, and 97 (see FIG. 3A) of the primary reflective mirror 7 to the circuit unit 11. In view of light distribution characteristics, the tubular members 317, 317, 319, and 319 are made of a translucent material, such as hard glass.

### 2. Embodiment 3-2

According to Embodiment 3-1, the plurality of LEDs are mounted on a single mounting board. However, the LEDs may be mounted on a plurality of mounting boards as in Embodiment 2-3. In other words, the number of LED modules disposed within the primary reflective mirror may be one or more. The following describes an example where five LED modules are disposed within the primary reflective mirror.

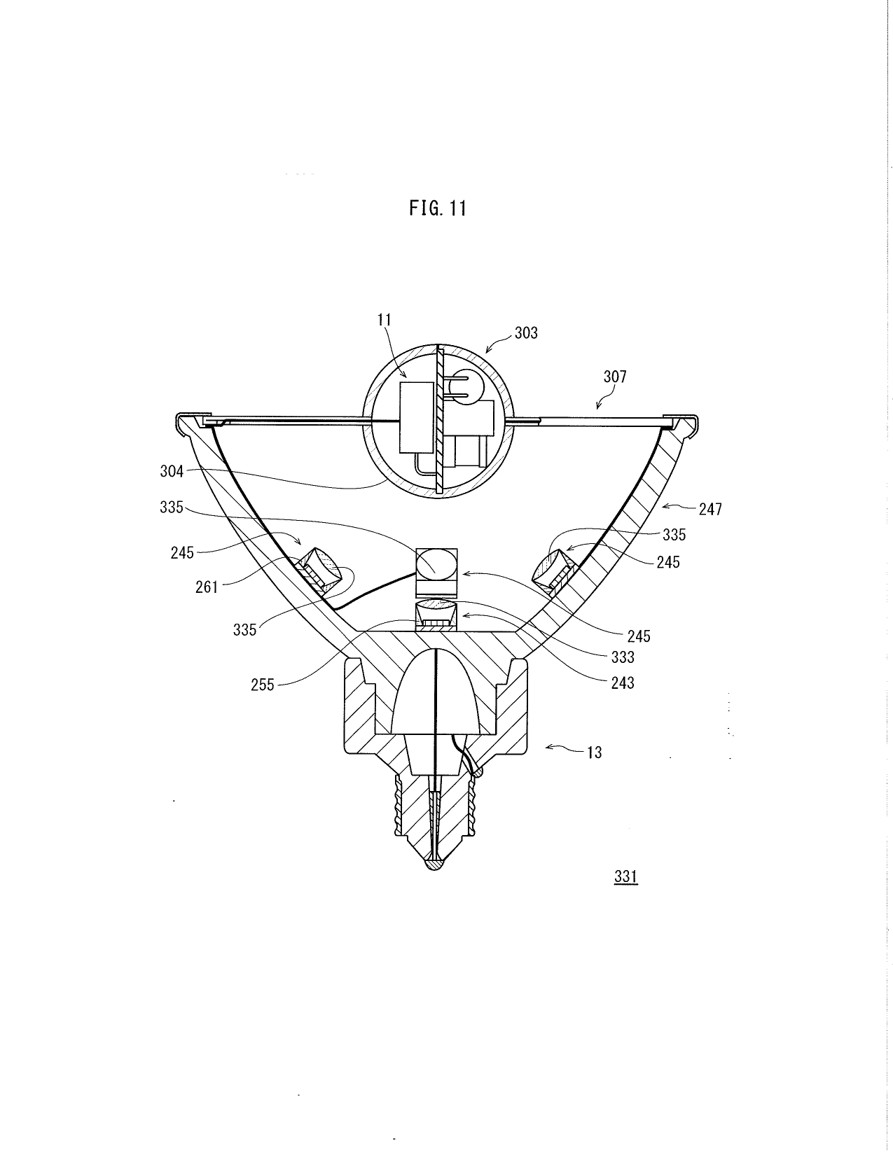

FIG. 11 is a cross-sectional view showing the structure of an LED lamp 331 according to Embodiment 3-2.

The LED lamp 331 according to Embodiment 3-2 includes a lens 333 and lenses 335, in addition to the five LED modules 243, 245, 245, 245, and 245, the primary reflective mirror 247, the circuit unit 11, the base 13, the circuit case 303, and the support 307. The lens 333 is attached to the LED module 243, and the lenses 335 to the respective LED modules 245. As in Embodiment 3-1, part of the outer peripheral surface of the circuit case 303 positioned within the primary reflective mirror 247 serves as a secondary reflective surface 304.

The LED modules 243 and 245 have the same structure as in Embodiment 2-3. The reflector 255 is attached to the LED module 243, and the reflectors 261 are attached to the respective LED modules 245. Note that the arrangement of the LED module 243 and the four LED modules 245, the wiring lines used for these LED modules 243 and 245, etc., are the same as in Embodiment 2-3.

The lens 333 is provided for the reflector 255, and the lenses 335 are provided for the reflectors 261. As in Embodiment 3-1, the lenses 333 and 335 are convex, and collimate light emitted from the LED modules 243 and 245 into parallel rays of light.

### Embodiment 4

According to Embodiments 1 to 3, the circuit case 15 is attached to the front plate 9 disposed at the side of the opening 31 of the primary reflective mirror 7, and the circuit case 303 is supported by the support 307 disposed at the open end of the primary reflective mirror 247. However, the circuit case may be supported and held according to a different structure. In Embodiment 4 described below, the circuit case is supported with use of a conductive member that conducts heat generated by the circuit unit toward the base.

Note that same reference signs are applied to the same elements as in Embodiments 1 to 3 described above.

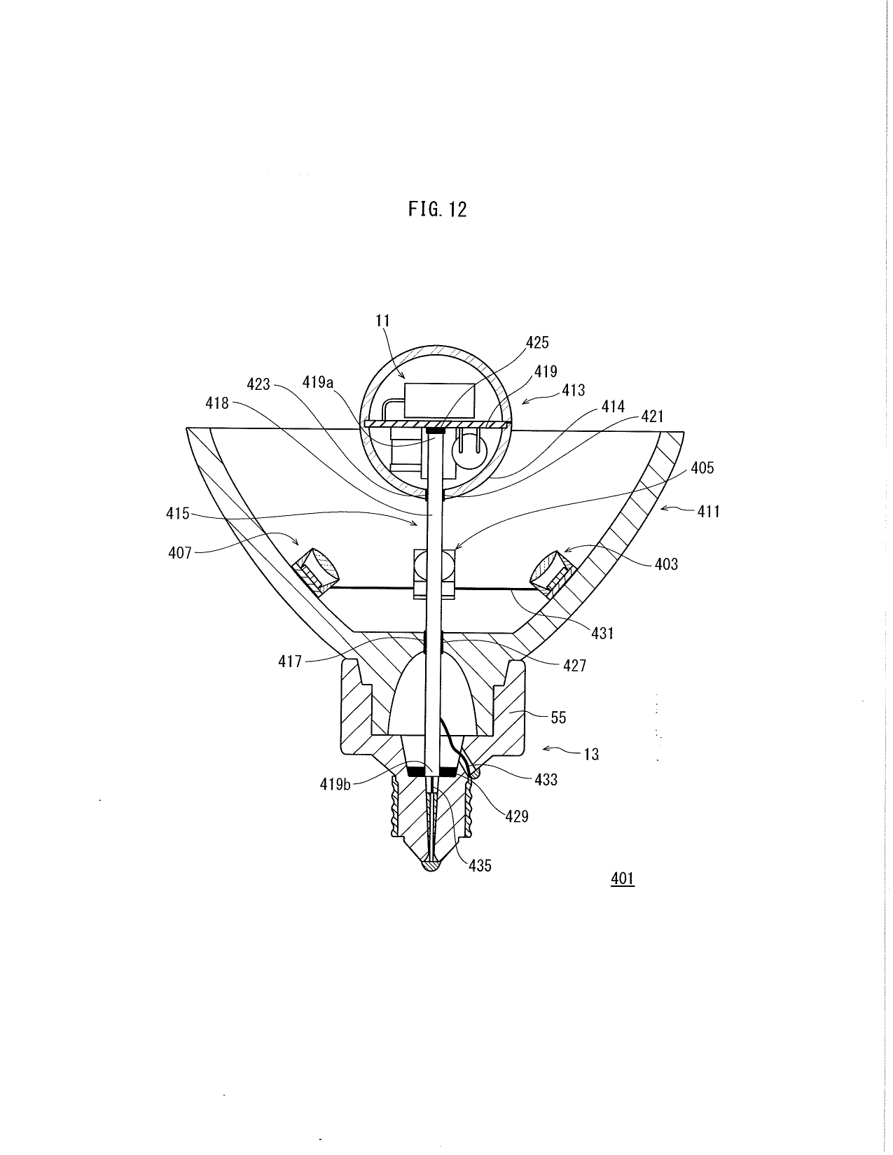

FIG. 12 is a cross-sectional view showing the structure of an LED lamp 401 according to Embodiment 4.

The LED lamp 401 according to Embodiment 4 includes four LED modules, i.e., LED modules 403, 405, 407, and 409 (the LED module 409 is not shown since it is located frontward in cross-sectional view), a primary reflective mirror 411, the circuit unit 11, the base 13, a circuit case 413, and a support 415.

Similarly to the LED modules 245 described above in Embodiment 3-2, the LED modules 403, 405, 407, and 409 are connected in series. When the LED lamp 401 is viewed from the side of an opening of the primary reflective mirror 411, the LED modules 403, 405, 407, and 409 are arranged around the optical axis of the primary reflective mirror 411 at predetermined intervals (in the present embodiment, an angle of 90 degrees).

The primary reflective mirror 411 is funnel-shaped, and has a through-hole 417 at the bottom thereof. A tubular member 418, which serves as the support 415, is inserted in the through-hole 417. A proximal end 419a of the tubular member 418 is connected to a circuit board 419 of the circuit unit 11, and a distal end 419b of the tubular member 418 is connected to the inside of the base 13.

As in Embodiment 3, the circuit unit 11 is housed in the circuit case 413, and both the circuit unit 11 and the circuit case 413 are supported by the support 415 in this state. Note that the lower part of the outer peripheral surface of the circuit case 413 serves as a secondary reflective surface. Specifically, the tubular member 418 is inserted in a through-hole 421 of the circuit case 413, and part of the tubular member 418 corresponding to the through-hole 421 is fixed to the circuit case 413 by adhesive 423. The proximal end 419a of the tubular member 418 is fixed to the circuit board 419 within the circuit case 413 by adhesive 425.

As described above, the distal end 419b of the tubular member 418 passes through the through-hole 417 of the primary reflective mirror 411 to reach the inside of the main body 55 of the base 13, and part of the tubular member 418 corresponding to the through-hole 417 is fixed to the primary reflective mirror 411 by adhesive 427. The distal end 419b of the tubular member 418 is fixed to the inside of the main body 55 of the base 13 by adhesive 429.

The electrical connections between the circuit unit 11 and the base 13 and between the circuit unit 11 and the LED modules 403, etc., are established by wiring lines 431, 433, and 435 provided inside the tubular member 418.

In order to effectively output light emitted from the LED modules 403, 405, 407, and 409 toward the outside of the primary reflective mirror 411, the tubular member 418 is desirably made of a translucent material, such as glass.

Note that the tubular member 418 may be made of a highly heat-conductive material (specifically, a material having a higher heat conductivity than air); and the circuit board 419 of the circuit unit 11 may be connected to the base 13 (or another member such as the primary reflective mirror 411). In this way, heat within the circuit case 413 and heat accumulated in the circuit board 419 can be conducted toward the base 13 (in this respect, the tubular member 418 is a conductive member). As a result, the heat load of the circuit unit 11 can be reduced.

From the standpoint of reducing the heat load of the circuit unit by conducting the heat of the circuit unit to the base, the conductive member is not limited to the tubular member made of glass or the like as described above. For example, the conductive member may be a metal wire such as a lead wire. Obviously, the conductive member is not limited to having a tubular shape, and may have a pillar shape, for example.

In the above example, the distal end of the conductive member is connected to the base. However, the distal end of the conductive member may be connected to a different member, such as the primary reflective mirror. Also, the proximal end of the conductive member may be connected to a member other than the circuit board, such as the electronic component that reaches the highest temperature among the electronic components mounted on the circuit board.

### Embodiment 5

The following describes in detail Embodiment 5 for implementing a lamp according to the present invention, with reference to the drawings. In Embodiment 5, a reflector LED lamp is taken as an example.

### 1. Overall Structure

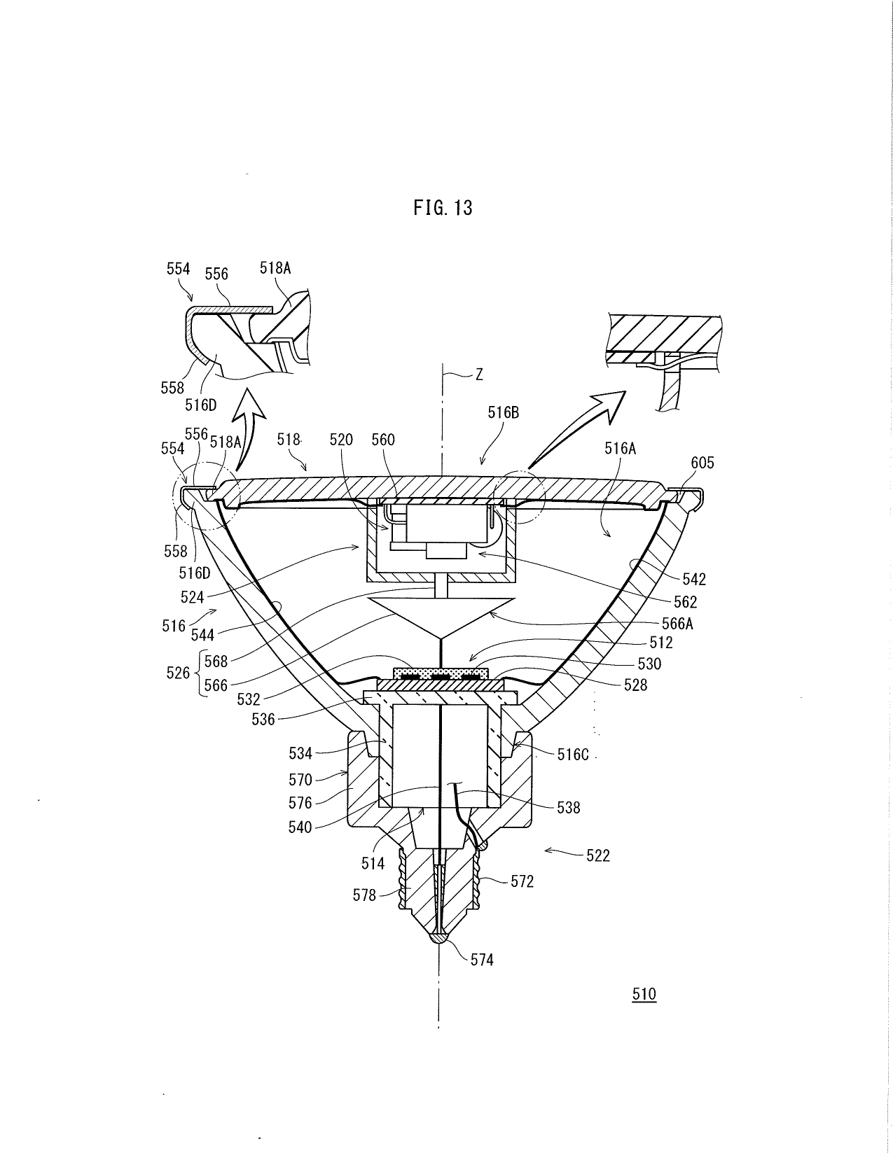

FIG. 13 is a cross-sectional view schematically showing the structure of a reflector LED lamp (hereinafter “LED lamp”) 510 according to Embodiment 5.

The LED lamp 510 includes an LED module 512, a mount 514, a primary reflective mirror 516, a front translucent plate (“front plate” in the present invention) 518, a circuit unit 520, a base 522, and a circuit case 524. The LED module 512 includes LEDs as light emitters, and is mounted on the mount 514. The primary reflective mirror 516 houses the LED module 512. The front translucent plate 518 is provided at an open end of the primary reflective mirror 516. The circuit unit 520 causes the LEDs to emit light. The base 522 is electrically connected to the circuit unit 520 which is housed in the circuit case 524. A secondary reflective mirror 526 is attached to the circuit case 524.

### (1) LED Module

The LED module 512 includes a mounting board 528, which is made from a printed wiring board having a disc shape, and a plurality of LEDs 530 mounted on the mounting board 528.

The LEDs 530 are electrically connected in series by a wiring pattern (not illustrated) of the mounting board 528, and are covered by a sealing member 532.

The sealing member 532 is mainly composed of a translucent material. If the wavelength of light emitted from the LEDs 530 needs to be converted into a predetermined wavelength, the translucent material is mixed with a wavelength conversion material. The translucent material may be a silicone resin, for example. Also, the wavelength conversion material may be phosphor particles, for example.

In the present example, the LEDs 530 emit blue light and, accordingly, phosphor particles for converting blue light into yellow light are used as the wavelength conversion material. In this way, blue light emitted from the LEDs 530 is combined with yellow light resulting from the wavelength conversion by the phosphor particles to produce white light, and the white light is emitted from the LED module 512 (LED lamp 510).

In this case, the top surface of the sealing member 532 containing the phosphor particles is the light-emitting surface of the LED module 512. The center of this light-emitting surface is positioned on an optical axis Z of the primary reflective mirror 516.

### (2) Mount

The mount 514 has a top-closed tubular shape as a whole (in the present example, a top-closed cylindrical shape), and includes a cylindrical portion 534 and a lid 536. The lid 536 has a disc-like shape, and closes one end of the cylindrical portion 534. The mount 514 is made of an insulating material having high heat conductivity, such as aluminum nitride (AlN). Alternatively, the mount 514 may be made of a metal material such as aluminum.

The LED module 512 (mounting board 528) is mounted on the outer surface of the lid 536. The mounting board 528 is fixed to the mount 514 by adhesive, which is not illustrated. The method or means for fixing the mounting board 528 is not limited to the above. For example, the mounting board 528 may be fixed with use of screws or the like.

### (3) Primary Reflective Mirror

The primary reflective mirror 516 is a concave mirror having a funnel shape (bowl shape) as a whole. In other words, the primary reflective mirror 516 has an opening (light-emitting opening) at one end, and a smaller opening than the light-emitting opening at the other end.

A concave surface 516A, which serves as a reflective surface of the primary reflective mirror 516, is spheroidal, for example. By appearance, the primary reflective mirror 516 is funnel-shaped, as described above. In this way, the shape of the LED lamp 510 closely resembles that of a general reflector halogen lamp, whereby the LED lamp 510 can be used as a light source that substitutes the halogen lamp. The primary reflective mirror 516 is made of aluminum or the like. The concave surface 516A of the primary reflective mirror 516 is given a mirror finish to be a reflective surface 516A.

The front translucent plate 518 is attached to the periphery of an opening 516B of the primary reflective mirror 516. The base 522 is attached to a neck portion 516C of the primary reflective mirror 516, which is a base of the primary reflective mirror 516. Here, the base of the primary reflective mirror 516 refers to an end portion located opposite the opening (516B) in a direction of the optical axis (Z).

Note that the primary reflective mirror 516 is not limited to being made of a single material as described above. For example, the funnel-shaped body may be made of glass, ceramic, or metal. Then, a metal film, a white resin film, or the like may be formed on the inner surface (concave surface) of the funnel-shaped body so as to form a reflective film (reflective surface).

On the concave surface 516A, wiring lines 538, 540, 542, and 544 are provided so as to electrically connect the base 522 to the circuit unit 520, and the circuit unit 520 to the LED module 512.

### (4) Front Translucent Plate

The front translucent plate 518 has a disc shape, and is made of glass or synthetic resin. The front translucent plate 518 is attached to the primary reflective mirror 516 to close the opening 516B. Accordingly, the front translucent plate 518 is also referred to as a closure. The circuit unit 520 is attached to the back surface of the front translucent plate 518, substantially at the center thereof. Also, the circuit unit 520 is covered by the circuit case 524.

On the back surface of the front translucent plate 518, wiring lines 546, 548, 550, and 552 are provided so as to electrically connect the base 522 and the circuit unit 520, and the circuit unit 520 to the LED module 512. Although not particularly limited, the attachment of the front translucent plate 518 to the primary reflective mirror 516 may be realized by an attachment member 554, for example.

The attachment member 554 utilizes an engaging structure, for example. Specifically, the attachment member 554 has an annular portion 556, and engagement portions 558 provided at different positions of the annular portion 556. The engagement portions 558 engage with a flange 516D of the opening 516B of the primary reflective mirror 516, in a state where the annular portion 556 makes contact with a periphery 518A of the front translucent plate 518.

### (5) Circuit Unit

The circuit unit 520 is composed of a circuit board 560, and various electronic components 562 mounted on the circuit board 560. The circuit board 560 is attached to the back surface of the front translucent plate 518. The circuit board 560 may be attached to the front translucent plate 518 with use of adhesive, screws, an engaging structure, etc., for example. In the present embodiment, the attachment is realized by adhesive.

As described below, the circuit unit 520 is electrically connected to the LED module 512 by the wiring lines 542, 544, 550, and 552, and to the base 522 by the wiring lines 538, 540, 546, and 548.

### (6) Circuit Case

The circuit case 524 has a bottomed-cylindrical shape, and is attached to the front translucent plate 518 so as to cover the circuit unit 520. The circuit case 524 is made of heat-resistant synthetic resin, for example. Although not particularly limited, the attachment of the circuit case 524 to the front translucent plate 518 may be realized with use of adhesive, for example. The circuit case 524, which is cylindrical, is positioned such that the central axis thereof coincides with the optical axis Z.

### (7) Secondary Reflective Mirror

The secondary reflective mirror 526 has a conical portion 566 and a shaft 568 extending from the conical portion 566 along the same axis as the central axis of the conical portion 566. Note that the conical portion 566 in the present example may be replaced with a pyramidal portion. The secondary reflective mirror 526 is made of aluminum, for example. A conical surface 566A of the conical portion 566 is given a mirror finish to serve as a secondary reflective surface 566A.

The secondary reflective mirror 526 is attached to the circuit case 524, with the shaft 568 being pressed into a hole in the bottom of the circuit case 524. In other words, the secondary reflective mirror 526 is disposed between the LED module 512 (the LEDs 530 to be specific) and the circuit unit 520. In a state where the secondary reflective mirror 526 is attached to the circuit case 524, the central axis of the conical portion 566 coincides with the optical axis Z. Also, the conical surface 566A of the conical portion 566 faces the LED module 512 (the LEDs 530 to be specific).

When viewed in the direction of the optical axis Z, the conical surface 566A, which serves as the secondary reflective surface of the secondary reflective mirror 526, desirably has a size equal to or slightly larger than the upper surface (light emitting surface) of the sealing member 532 of the LED module 512. This is to reflect, insofar as possible, light emitted from the LED module 512 in the direction of the optical axis Z.

The taper angle of the conical portion 566 is set such that when light emitted from the LED module 512 reaches the conical surface 566A, the light can be reflected on the conical surface 566A toward the reflective surface 516A of the primary reflective mirror 516 insofar as possible.

### (8) Base

There are various types of bases, and the base 522 may be of any type. In the present embodiment, the base 522 is of an Edison type, the size of which is E11, for example.

The base 522 includes a main body 570, a shell 572, and an eyelet 574. One end of the main body 570 is attached to the primary reflective mirror 516 and the mount 514. The shell 572 is attached to the main body 570. The eyelet 574 is provided at the other end of the main body 570. Note that the shell 572 is connected to the wiring line 538, and the eyelet 574 is connected to the wiring line 540.

The main body 570 has an inner space (i.e., a recess which is recessed from one end of the main body 570 to the other end thereof). Also, the main body 570 includes a large-diameter cylindrical portion 576 and a small-diameter cylindrical portion 578 having a smaller outer diameter than the large-diameter cylindrical portion 576. The large-diameter cylindrical portion 576 is in a bottomed cylindrical shape, and has a cylindrical part. The shape and size of the inner surface of the cylindrical part correspond to those of the outer surface of the cylindrical portion 534 of the mount 514. The small-diameter cylindrical portion 578 extends toward the eyelet 574 from the bottomed end of the large-diameter cylindrical portion 576. The cross section of each of the large-diameter cylindrical portion 576 and the small-diameter cylindrical portion 578 is annular. The central axis of the large-diameter cylindrical portion 576 coincides with the central axis of the small-diameter cylindrical portion 578.

The shell 572 has a threaded outer peripheral surface, and covers the small-diameter cylindrical portion 578. The shell 572 is fixed to the small-diameter cylindrical portion 578 by adhesive. The wiring line 540 passes through the inside of the small-diameter cylindrical portion 578 from one end to the other, and is soldered to the eyelet 574 at the other end of the small-diameter cylindrical portion 578.

### 2. Electrical Connection

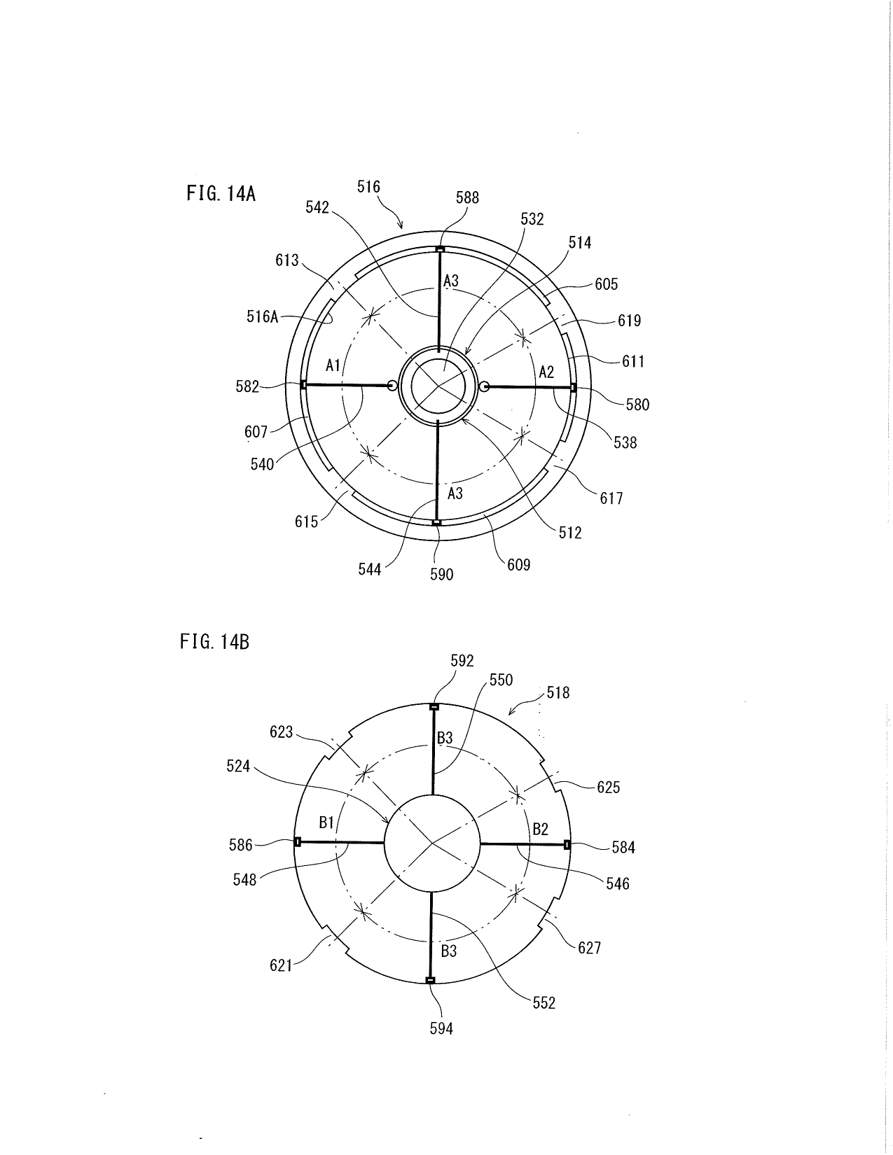

FIGS. 14A and 14B illustrate an electrical connection. FIG. 14A shows the primary reflective mirror 516 viewed from the side of the opening 516B. FIG. 14B shows the back surface of the front translucent plate 518.

### (1) Electrical Connection Between Circuit Unit and Base

As in Embodiment 1, the circuit unit 520 and the base 522 are connected to each other via the wiring lines 538, 540, 546, and 548. As shown in FIG. 13 and FIG. 14A, the wiring lines 538 and 540 are provided on the mount 514 and the primary reflective mirror 516. As shown in FIG. 14B, the wiring lines 546 and 548 are provided on the back surface of the front translucent plate 518.

When the front translucent plate 518 is attached to the primary reflective mirror 516, terminals 584 and 586 on the front translucent plate 518 make contact with terminals 580 and 582 on the primary reflective mirror 516, whereby the base 522 and the circuit unit 520 are electrically connected to each other.

### (2) Connection Between Circuit Unit and LED Module

As in Embodiment 1, the circuit unit 520 and the LED module 512 are connected to each other via the wiring lines 542, 544, 550, and 552. As shown in FIG. 13 and FIG. 14A, the wiring lines 542 and 544 are provided on the primary reflective mirror 516. As shown in FIG. 14B, the wiring lines 550 and 552 are provided on the back surface of the front translucent plate 518.

When the front translucent plate 518 is attached to the primary reflective mirror 516, terminals 592 and 594 on the front translucent plate 518 make contact with terminals 588 and 590 on the primary reflective mirror 516, whereby the LED module 512 and the circuit unit 520 are electrically connected to each other.

### (3) Prevention of Erroneous Attachment

As shown in FIG. 13 and FIGS. 14A and 14B, a plurality of steps (four steps in the present embodiment) are formed at an opening end of the primary reflective mirror 516. Specifically, steps 605, 607, 609, and 611 are formed along the periphery of the opening of the primary reflective mirror 516.

Along the periphery of the front translucent plate 518, cutouts 621, 623, 625, and 627 are formed. The cutouts 621, 623, 625, and 627 correspond to inter-step gaps 613, 615, 617, and 619 that are each a gap between two adjacent steps from among the steps 605, 607, 609, and 611 of the primary reflective mirror 56.

The intervals (angles A1, A2, and A3) that are each an interval between two adjacent centers from among the centers of the inter-step gaps 613, 615, 617, and 619, are the same as the intervals (angles B1, B2, and B3) that are each an interval between two adjacent centers from among the centers of the cutouts 621, 623, 625, and 627. The angles A1 and B1 are different from the angles A2 and B2. The back surface of the front translucent plate 518 makes contact with the edge of the opening 516B of the primary reflective mirror 516 only when the cutouts 621, 623, 625, and 627 of the front translucent plate 518 are respectively positioned at the inter-step gaps 613, 615, 617, and 619 (i.e., no other positional relationships enable the contact between the back surface of the front translucent plate 518 and the edge of the opening 516B). This prevents erroneous attachment of the front translucent plate 518 to the primary reflective mirror 516.

### (4) Summary

The LED lamp 510 as shown in FIG. 13 has the stated structure. With this structure, heat generated by the LEDs 530 during the operation is conducted to the base 522 via the mounting board 528 and the mount 514, and is discharged to, via the socket of the lighting fixture to which the LED lamp 510 is attached, other components of the lighting fixture, and further to the ceiling and the wall to which the lighting fixture is attached.

In the LED lamp 510, the circuit unit 520 is housed in a space located opposite the base 522 across the mounting board 534, i.e., in a direction in which the LEDs 530 emit light. That is, the circuit unit 520 is not located in the heat conductive path from the LED module 512 to the base 522. Accordingly, even when a large number of LEDs are used for the LED module of the LED lamp 510 (i.e., the number of LEDs is increased) in order to use the LED lamp 510 as a substitute of a halogen lamp, the circuit unit 520 is less likely to be affected by heat generated by the LED module. This suppresses a reduction in the lifetime of the electronic components constituting the circuit unit 520.

Also, part of light emitted from the LEDs 530 is reflected on the secondary reflective surface 566A of the secondary reflective mirror 526 to be directed to the reflective surface 516A of the primary reflective mirror 516, and is further reflected on the reflective surface 516A. The light reflected on the reflective surface 516A then passes through the front translucent plate 518 from the opening 516B, and is emitted outside the LED lamp 510.

The LEDs 530 have a strong light directionality. Accordingly, without the secondary reflective mirror 526, most of the light emitted from the LEDs 530 will be directly output from the LED lamp 510 in the direction of the optical axis Z (in the present example, the light will be blocked by the circuit unit 520 and the circuit case 524), and will not be reflected on the reflective surface 516A of the primary reflective mirror 516. As a result, light distribution characteristics using the primary reflective mirror 516 cannot be obtained.

According to the present embodiment, however, the secondary reflective mirror 526 is disposed forward in the direction of the optical axis Z. In this way, light emitted from the LEDs 530 is mostly reflected on the reflective surface 516A of the primary reflective mirror 516, enabling obtainment of light distribution characteristics using the primary reflective mirror 516 insofar as possible.

Also, even if a rise in temperature occurs in the base 522 and the members surrounding the base 522 due to the heat generated by the LEDs 530 during the operation, the circuit unit 520 is less affected by the temperature rise since the circuit unit 520 is disposed at the side of the opening of the primary reflective mirror 516. Accordingly, even if the temperature of the base 522 is further raised by, for example, an increase in the input current to the LEDs 530 or the size reduction of the members constituting the lamp, the circuit unit 520 is less affected by the heat load caused by the temperature rise. This reduces the necessity of new heat dissipation measures.

### Embodiment 6

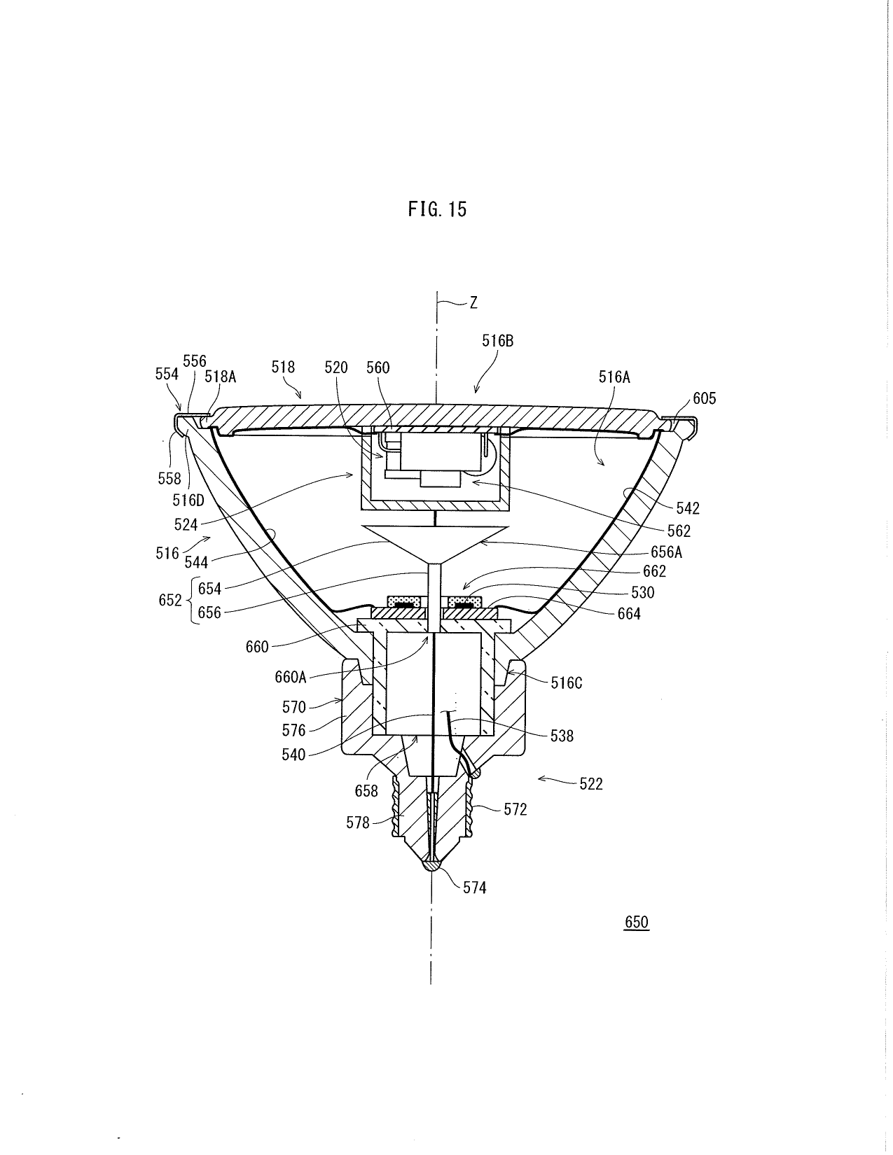

FIG. 15 is a cross-sectional view schematically showing the structure of a reflector LED lamp (hereinafter, simply “LED lamp”) 650 according to Embodiment 6.

Note that the LED lamp 650 basically has the same structure as the LED lamp 510 according to Embodiment 5, except the structure of the secondary reflective mirror and the attachment method thereof. In FIG. 15, the same components as those of the LED lamp 510 are therefore given the same reference signs as the LED lamp 510, and their explanations are omitted. The following mainly describes the differences.

The LED lamp 650 has a secondary reflective mirror 652. As in Embodiment 5, the secondary reflective mirror 652 has a conical portion 654 and a shaft 656. Unlike in Embodiment 5, the shaft 656 extends from the apex of the conical portion 654 in the direction of the central axis of the conical portion 654. A conical surface 656A of the conical portion 654 is given a mirror finish to serve as a secondary reflective surface 656A.

Also, according to Embodiment 5, the secondary reflective mirror is attached to the circuit case. However, in the LED lamp 650, the circuit case is attached to a mount 658. The mount 658 has a lid 660. The lid 660 has a through-hole 660A at the center thereof. A tip of the shaft 656 is pressed into the through-hole 660A, whereby the secondary reflective mirror 652 is attached to the mount 658.

A mounting board 664 of an LED module 662 is annular, so that the shaft 656 can be pressed into the through-hole 660A. The plurality of LEDs 530 are mounted on the mounting board 664 in the peripheral direction thereof. In other words, the shaft 656 is inserted into a hollow portion of the mounting board 664.

The effects and advantages of the LED lamp 650 having the stated structure are basically the same as those of the LED lamp 510, and descriptions thereof are omitted.

### <Modification of Secondary Reflective Mirror>

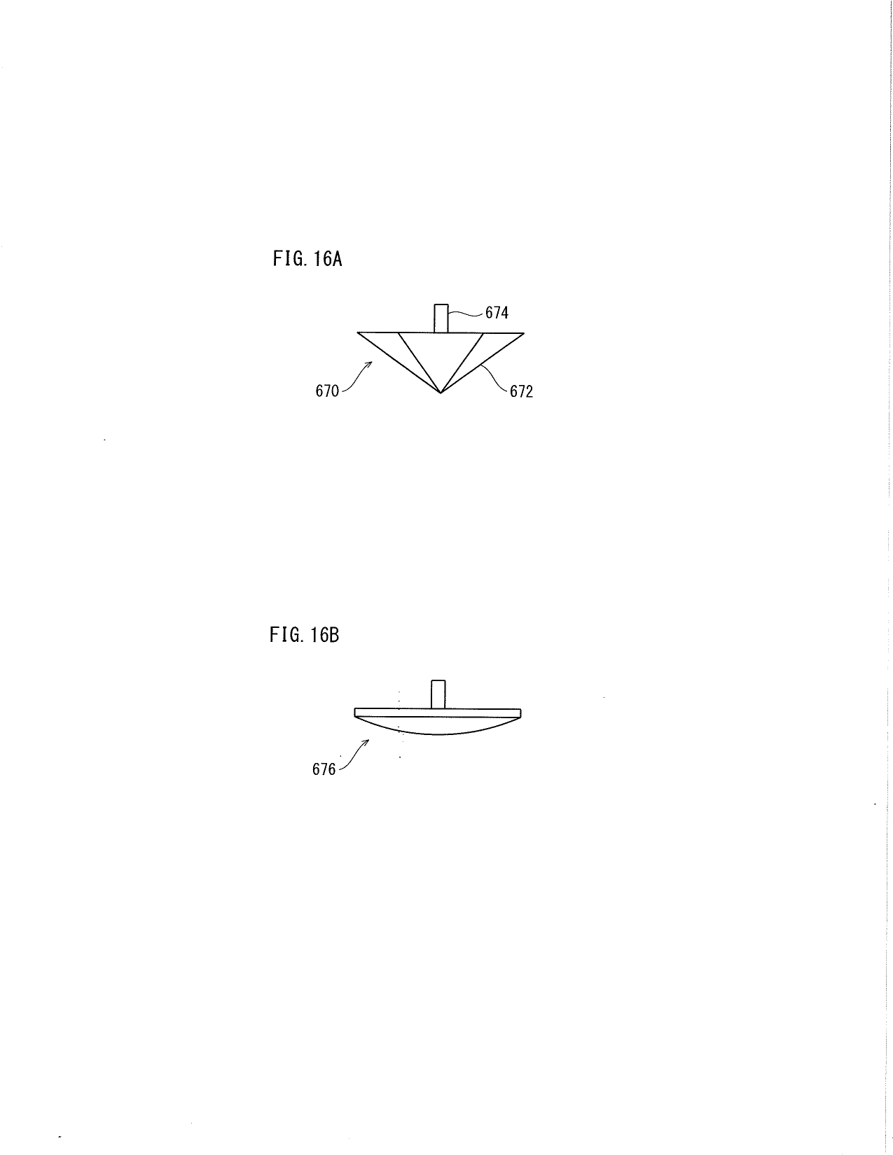

Each of FIGS. 16A and 16B schematically shows the structure of a secondary reflective mirror according to a modification.

A secondary reflective mirror 670 shown in FIG. 16A has a pyramidal (hexagonal pyramid in the present example) portion 672, and a shaft 674 extending from the pyramidal portion 672 along the same axis as the central axis of the pyramidal portion 672. The shape of the pyramidal portion is not limited to a hexagonal pyramid, and may be a triangular pyramid, a pentagonal pyramid, or a polygonal pyramid having a base with seven corners or more.

A secondary reflective mirror 676 shown in FIG. 16B is a convex mirror corresponding to the conical portion of each secondary reflective mirror described above.

### <Modifications>

The structure of the present invention has been described above based on Embodiments 1 through 4. The present invention, however, is not limited to the embodiments above. For example, the following modifications may be adopted.

### 1 Primary Reflective Mirror

### (1) Shape

According to the above embodiments, etc., the reflective surface of the primary reflective mirror is spheroidal. Part of the light emitted from the LEDs is reflected toward the primary reflective mirror with use of the secondary reflective surface of the circuit case and focused by the primary reflective mirror. The focused light is then output from the LED lamp (as a spotlight). However, the reflective surface of the primary reflective mirror may have a different shape, such as a paraboloidal shape. In this case, a parallel light is output from the LED lamp.

Alternatively, the reflective surface of the primary reflective mirror may have a shape other than a spheroidal shape or a paraboloidal shape. For example, it may be polygonal or tubular.

### (2) Material

According to the above embodiments, etc., the primary reflective mirror is made of a material such as glass, ceramic, or metal. However, it may be made of a different material. For example, the primary reflective mirror may be made of resin.

The reflective surface is made of a metal film or a white resin. However, it may be made of a different material. For example, the reflective surface may be made of glass or resin which is translucent so as to produce leak light.

### (3) Front Plate

As described above in Embodiments 1 and 2, the opening of the primary reflective mirror may be closed or, as described in Embodiment 3, (part of) the opening of the primary reflective mirror may be left open.

### 2. Base

Although the Edison-type base is used in the above embodiments, etc., another type such as a pin-type (specifically, G-type such as GY and GX) or a swan-type may be used.

According to the embodiments, etc. above, the base and the mount are hollow. However, the internal space of each of the base and the mount may be filled with an insulating material having a higher heat conductivity than air. With such a structure, the heat generated by the LED module during the operation is conducted to the lighting fixture via the base and the socket. This improves the heat dissipation characteristics of the lamp as a whole. One example of the insulating material is a silicone resin.

### 3. LED Module

### (1) Mounting Board

The mounting board may be an existing mounting board, such as a resin board, a ceramic board, or a metal-based board composed of a resin plate and a metal plate.

### (2) LED

In the embodiments, etc. above, the LEDs emitting blue light and the conversion member converting blue light into yellow light are used. However, LEDs that emit light of another color may be used. In this case, it is necessary to use a wavelength conversion material that converts the color of light to the desired color for the LED lamp. For example, near-ultraviolet LEDs may be used in combination with a phosphor formed from the mixture of a red phosphor, a blue phosphor and a green phosphor.

Although the embodiments, etc. above utilize the LEDs of a single type so that the LED module (the LED lamp) emits white light, three types of LEDs, namely LEDs emitting blue light, red light and green light may be used, and these colors of light may be mixed to obtain white light.

The number of LEDs is not particularly limited, and may be changed according to the required luminance, for example. The LED module is composed of the chip-type LEDs mounted on the mounting board. However, the LED module may be composed of SMD (Surface Mount Device)-type LEDs mounted on the mounting board. In this case, the bottom periphery of the primary reflective mirror having the concave surface may be used as a mount, and the SMD-type LEDs may be arranged in the pattern of a ring centering on the optical axis Z. At this time, the LEDs may be arranged in a ring pattern independently without the LED module including the chip-type LEDs or, alternatively, together with the LED module including the chip-type LEDs.

### (3) Sealing Member

According to the above embodiments, etc., the sealing member covers all the LEDs mounted on the mounting board. However, a single LED may be covered with a single sealing member, or the LEDs may be grouped and a predetermined number of LEDs may be covered with a single sealing member.

Moreover, although phosphor particles are contained in the translucent material in the above embodiments, etc., a phosphor layer containing phosphor particles may be formed on the translucent material instead. Furthermore, a wavelength conversion member such as a phosphor plate containing phosphor particles may be disposed in the direction in which the LEDs emit light, in addition to the sealing member (the LED module).

### 4. Wavelength Conversion

According to the above embodiments, etc., the sealing member contains phosphor particles that convert the wavelength of light emitted from the LEDs, and the wavelength conversion plate is disposed in the direction in which the LED module emits light. However, a phosphor layer containing phosphor particles may be applied to the back surface of the front plate 9 in Embodiments 1 and 2. Alternatively, such a phosphor layer may be applied to the lens 305 in Embodiment 3.

### 5. Support

According to Embodiment 3, the wiring lines 321 are inserted in the translucent tubular members 317 and 319 made of glass or the like, and the tubular members 317 and 319 in this state are used as the support of the circuit case 203. However, different tubular members, support rods, etc., may be used instead, as long as they are hard enough to hold the circuit unit 11.

In view of light distribution characteristics, light absorption characteristics, etc., the tubular members and the support rods are desirably made of a material having a high transmissivity. In case of using the support rods, lead wires may be wound around or provided along the support rods.

### 6. Circuit Unit

According to the above embodiments, etc., the circuit unit 11 has a single circuit board, i.e., the circuit board 47 or the circuit board 309, on which the plurality of electronic components are mounted, and the circuit unit 11 is entirely housed in the circuit case 15 or 303. However, part of the circuit unit 11 may not be housed in the circuit case 15 or 303. In other words, part of the circuit unit 11 may be located outside the circuit case 15 or 303.

For example, the circuit unit may include a first circuit board and a second circuit board. The plurality of electronic components may be divided into two groups which are respectively mounted on the first circuit board and the second circuit board. The first circuit board and the electronic components mounted thereon may be housed in the circuit case, whereas the second circuit board and the electronic components mounted thereon may be disposed outside the circuit case.

Also, not all the electronic components constituting the circuit unit 11 may be necessarily disposed within the primary reflective mirror 7 or 247. For example, electronic components not housed in the circuit case may be disposed between the LED module and the base, or within the base.

In this case, the electronic components disposed between the LED module and the base, or within the base desirably have high heat resistance. With such a structure, the capacity of the inner space of the circuit case can be reduced by the volume of the electronic components disposed outside the circuit case. This enables downsizing the circuit case and reducing the amount of light blocked by the circuit case.

According to the above embodiments, etc., the circuit board 47 of the circuit unit 11 is arranged such that a main surface of the circuit board 47 is perpendicular to the lamp axis, and the circuit board 309 is arranged such that a main surface of the circuit board 309 is parallel to the lamp axis. However, the circuit board may be arranged such that a main surface of the circuit board is slanted with respect to the lamp axis.

Although the arrangement of the electronic components mounted on the circuit board is not described in the above embodiments, etc., electronic components of a large size (volume, height, etc.) may be arranged on the center of the circuit board, and electronic parts of a small size may be arranged around them. This leads to an effective use of the space within the circuit case.

### 7. Circuit Case

According to the above embodiments, etc., the circuit case 15 having a hemispherical shape and the circuit case 303 having a spherical shape are used. However, it is not limited to such. The circuit case may have the shape of a truncated tetrahedron, a truncated hexahedron, a truncated octahedron, a truncated dodecahedron, a truncated icosahedron, a rhombicuboctahedron, a rhombicosidodecahedron, a rhombitruncated cuboctahedron, a rhombitruncated icosidodecahedron, or a semi-regular polyhedron other than a rhombicubooctahedron, such as a snub cube or a snub dodecahedron.

Alternatively, the circuit case may have the shape of a regular polyhedron, such as a regular tetrahedron, a regular hexahedron, a regular octahedron, a regular dodecahedron or a regular icosahedron. Still further, the circuit case may alternatively have the shape of a quasi-regular polyhedron, such as a cuboctahedron, an icosidodecahedron, a dodecadodecahedron, a great icosidodecahedron, a small ditrigonal icosidodecahedron, a ditrigonal dodecadodecahedron, a great ditrigonal icosidodecahedron, a tetrahemihexahedron, an octahemioctahedron, a cubohemioctahedron, or a small icosihemidodecahedron.

Alternatively, the circuit case may have the shape of a regular star polyhedron such as a small stellated dodecahedron, a great dodecahedron, a great stellated dodecahedron, or a great icosahedron. Still further, the circuit case may alternatively have the shape of a uniform polyhedron, such as a small cubicuboctahedron, a great cubicuboctahedron, a cubitruncated cuboctahedron, a uniform great rhombicuboctahedron, a small rhombihexahedron, a great truncated cuboctahedron, a great rhombihexahedron, a small icosicosidodecahedron, a small snub icosicosidodecahedron, a small dodecicosidodecahedron, a truncated great dodecahedron, a rhombidodecadodecahedron, a truncated great icosahedron, a small stellated truncated dodecahedron, a great stellated truncated dodecahedron, a great dirhombicosidodecahedron, or a great disnub dirhombidodecahedron.

Alternatively, the circuit case may have the shape of an Archimedean dual, a deltahedron, a Johnson solid, a stellation, a zonohedron, a parallelohedron, a rhombohedron, a polyhedral compound, a compound, a perforated polyhedron, any of Leonardo da Vinci's polyhedra, a ring of regular tetrahedra, and a regular skew polyhedron.

### 8. Other

In the above embodiments, etc., a heat pipe may be provided to connect the circuit unit and the base, thereby transferring heat from the circuit unit to the base. For example, a rod-like heat pipe made of a material having high heat conductivity may be disposed between the circuit unit and the base, with one end of the heat pipe thermally connected to the circuit unit, and the other end thermally connected to the base. In this case, the heat pipe is insulative so that no current flows between the circuit unit and the base via the heat pipe.

### INDUSTRIAL APPLICABILITY

The present invention is applicable for the reduction in size and the improvement in brightness of lamps.

### REFERENCE SIGNS LIST

1, 201, 211, 241, 301, 331, and 401 LED lamp
3, 213, 243, 245, 403, 405, and 407 LED module
7, 247, and 411 primary reflective mirror
11 circuit unit
13 and 17 base
65 secondary reflective surface

1. A lamp comprising:
a primary reflective mirror being bowl-shaped with an opening at one end, and having an inner surface serving as a reflective surface;
a base provided at another end of the primary reflective mirror;
semiconductor light-emitting elements disposed within an envelope composed of at least the primary reflective mirror and the base;
a circuit unit configured to receive power via the base and cause the semiconductor light-emitting elements to emit light; and
a secondary reflective surface configured to reflect light emitted from the semiconductor light-emitting elements toward the reflective surface of the primary reflective mirror, wherein
at least part of the circuit unit is disposed within the primary reflective mirror closer to the opening than to the base in a direction in which the semiconductor light-emitting elements emit light, and
the secondary reflective surface is located between the at least part of the circuit unit and the semiconductor light-emitting elements, and reflects light, emitted from the semiconductor light-emitting elements to the at least part of the circuit unit, toward the reflective surface of the primary reflective mirror.

2. The lamp of claim 1, further comprising
a circuit case, wherein
the at least part of the circuit unit is housed in the circuit case, and
the secondary reflective surface is a surface of the circuit case and faces the semiconductor light-emitting elements.

3. The lamp of claim 2, further comprising
a light focusing member disposed within the primary reflective mirror and configured to focus light emitted from the semiconductor light-emitting elements to the circuit case.

4. The lamp of claim 3, wherein
the light focusing member is at least one of a reflector or a lens.

5. The lamp of claim 3, wherein
the semiconductor light-emitting elements and the light focusing member are mounted on a mounting board.

6. The lamp of claim 1 further comprising
a front plate, wherein
the opening of the primary reflective mirror is closed by the front plate, and
the at least part of the circuit unit is attached to the front plate.

7. The lamp of claim 1, further comprising
a secondary reflective mirror, wherein
the secondary reflective surface is a reflective surface of the secondary reflective mirror.

8. The lamp of claim 7, wherein
the reflective surface of the secondary reflective mirror is either conical or pyramidal, and faces the semiconductor light-emitting elements.

9. The lamp of claim 7, further comprising
a front plate, wherein
the opening of the primary reflective mirror is closed by the front plate, and
the part of the circuit unit is attached to the front plate.

10. The lamp of claim 7, wherein
the part of the circuit unit is disposed within the primary reflective mirror closer to the opening than to the base in the direction in which the semiconductor light-emitting elements emit light, and a remaining part of the circuit unit is disposed closer to the base than to the opening and in a direction opposite the direction in which the semiconductor light-emitting elements emit light.

11. The lamp of claim 4, wherein
the semiconductor light-emitting elements and the light focusing member are mounted on a mounting board.

12. The lamp of claim 11, further comprising
a front plate, wherein
the opening of the primary reflective mirror is closed by the front plate, and
the at least part of the circuit unit is attached to the front plate.
